(19) United States
(12) Patent Application Publication
(10) Pub. No.: US 2012/0089700 A1
(43) Pub. Date: Apr. 12, 2012

(54) PROXY SERVER CONFIGURED FOR HIERARCHICAL CACHING AND DYNAMIC SITE ACCELERATION AND CUSTOM OBJECT AND ASSOCIATED METHOD

(75) Inventors: Ido Safruti, San Francisco, CA (US); Udi Trugman, Alfe-Menashe (IL); David Drai, Kfar Yona (IL); Ronni Zehavi, Sunnyvale, CA (US)

(73) Assignee: Contendo, Inc., Sunnyvale, CA (US)

(21) Appl. No.: 12/901,571

(22) Filed: Oct. 10, 2010

(51) Int. Cl. G06F 15/16

(52) U.S. Cl. 709/217

(57) ABSTRACT

A method is provided to deliver content over a network comprising: receiving a request by a proxy server; determining by the proxy server whether the received request involves content to be delivered from an origin using one or more persistent network connections or from a cache; sending by the proxy server a request to retrieve the content from a cache when the request is determined to involve cached content; and sending by the proxy server a request using one or more persistent network connections to retrieve the content from the origin when the content is to be is determined to involve content to be delivered using one or more persistent network connections.

### CROSS REFERENCE TO RELATED APPLICATION

The subject matter of this application is related to the subject matter of commonly owned U.S. patent application Ser. No. 12/758,017 filed Apr. 11, 2010, entitled, Proxy Server Configured for Hierarchical Caching and Dynamic Site Acceleration and Associated Method, which is expressly incorporated herein by this reference.

### BACKGROUND

Content delivery networks (CDNs) comprise dedicated collections of servers located across the Internet. Three main entities participate in a CDN: content provider, CDN provider and end users. A content provider is one who delegates Uniform Resource Locator (URL) name space for web objects to be distributed. An origin server of the content provider holds these objects. CDN providers provide infrastructure (e.g., a network of proxy servers) to content providers to achieve timely and reliable delivery of content over the Internet. End users are the entities that access content provided on the content provider's origin server.

In the context of CDNs, content delivery describes an action of delivering content over a network in response to end user requests. The term ‘content’ refers to any kind of data, in any form, regardless of its representation and regardless of what it represents. Content generally includes both encoded media and metadata. Encoded content may include, without limitation, static, dynamic or continuous media, including streamed audio, streamed video, web pages, computer programs, documents, files, and the like. Some content may be embedded in other content, e.g., using markup languages such as HTML (Hyper Text Markup Language) and XML (Extensible Markup Language). Metadata comprises a content description that may allow identification, discovery, management and interpretation of encoded content.

The basic architecture of the Internet is relatively simple: web clients running on users' machines use HTTP (Hyper Text Transport Protocol) to request objects from web servers. The server processes the request and sends a response back to the client. HTTP is built on a client-server model in which a client makes a request of the server.

HTTP requests use a message format structure as follows:

<request-line>
<general-headers>
<request-headers>
<entity-headers>
<empty-line>
[<message-body>]
[<message-trailers>]

The generic style of request line that begins HTTP messages has a three-fold purpose: to indicate the command or action that the client wants perform; to specify a resource upon which the action should be taken; and to indicate to the server version of HTTP the client is using. The formal syntax for the request line is:

<METHOD> <request-uri> <HTTP-VERSION>

The ‘request URI’ (uniform resource identifier) identifies the resource to which the request applies. A URI may specify a name of an object such as a document name and its location such as a server on an intranet or on the Internet. When a request is sent to a proxy server a URL may be included in the request line instead of just the URI. A URL encompasses the URI and also specifies the protocol.

HTTP uses Transmission Control Protocol (TCP) as its transport mechanism. HTTP is built on top of TCP, which means that HTTP is an application layer connection oriented protocol. A CDN may employ HTTP to request static content, streaming media content or dynamic content.

Static content refers to content for which the frequency of change is low. It includes static HTML pages, embedded images, executables, PDF files, audio files and video files. Static content can be cached readily. An origin server can indicate in an HTTP header that the content is cacheable and provide caching data, such as expiration time, etag (specifying the version of the file) or other.

Streaming media content may include streaming video or streaming audio and may include live or on-demand media delivery of such events as news, sports, concerts, movies and music.

In a typical CDN service, a caching proxy server will cache the content locally, However, if a caching proxy server receives a request for content that has not been cached, it generally will go directly to an origin server to fetch the content. In this manner, the overhead required within a CDN to deliver cacheable content is minimized. Also, fewer proxy servers within the CDN will be involved in delivery of a content object, thereby further reducing the latency between request and delivery of the content. A content provider/origin that has a very large library of cacheable objects (e.g., tens or hundreds of millions of objects, or more), typically for a “long-tail” content/application, may experience cache exhaustion due to the limited number of objects that can be cached, which can result in a high cache miss ratio. Hierarchical cache has been employed to avoid cache exhaustion when a content provider serves a very large library of objects. Hierarchical caching involves splitting such library of objects between a cluster of proxy servers, so that each proxy will store a portion of the library. When a proxy server that is a constituent of a hierarchical cache receives a content request, it should know which proxy server in a cluster of proxies is designated to cache the requested content so that such receiving proxy can fetch the requested content from the proxy that caches it.

Dynamic content refers to content that changes frequently such as content that is personalized for a user and to content that is created on-demand such as by execution of some application process, for example. Dynamic content generally is not cacheable. Dynamic content includes code generated pages (such as PHP, CGI, JSP or ASP), transactional data (such as login processes, check-out processes in an ecommerce site, or a personalized shopping cart). In some cases, cacheable content is delivered using DSA. Sometimes, the question of what content is to be delivered using DSA techniques, such as persistent connections, rather than through caching may involve an implementation choice. For example, caching might be unacceptable for some highly sensitive data and SURL and DSA may be preferred over caching due to concern that cached data might be compromised. In other cases, for example, the burden of updating a cache may be so great as to make DSA more appealing.

Dynamic site acceleration (DSA) refers to a set of one or more techniques used by some CDNs to speed the transmission of non cacheable content, across a network. More specifically, DSA, sometimes referred to as TCP acceleration, is a method used to improve performance of an HTTP or a TCP connection between end nodes on the internet, such as an end user device (an HTTP client) and an origin server (an HTTP server) for example. DSA has been used to accelerate the delivery of content between such end nodes. The end nodes typically will communicate with each other through one or more proxy servers, which are typically located close to at least one of the end nodes, so as to have a relatively short network roundtrip between such node. Acceleration can be achieved through optimization of the TCP connection between proxy servers. For example, DSA typically involves keeping persistent connections between the proxies and between certain end nodes (e.g., the origin) that the proxies communicate with so as to optimize the TCP congestion window for faster delivery of content over the connection. In addition, DSA may involve optimizations of the higher level applications using a TCP connection (such as HTTP), for example. Reusing connections from a connection pool also can contribute to DSA.

There has been an increasing need to provide CDN content providers with flexibility in determining how end user requests for content are managed for CDNs that effectively combine both caching and DSA.

### BRIEF DESCRIPTION OF THE DRAWINGS

FIG. 1 is an illustrative architecture level drawing to show the relationships among servers in a hierarchical cache in accordance with some embodiments.

FIG. 2 is an illustrative architecture level drawing to show the relationships among servers in two different dynamic site acceleration (DSA) configurations in accordance with some embodiments.

FIG. 3A is an illustrative drawing of a process/thread that runs on each of the proxy servers in accordance with some embodiments.

FIGS. 3B-3C are an illustrative set of flow diagrams that show additional details of the operation of the thread (FIG. 3B) and its interaction with an asynchronous IO layer 3 (FIG. 3C) referred to as NIO.

FIG. 4 is an illustrative flow diagram representing an application level task within the process/thread of FIG. 3A that runs on a proxy server in accordance with some embodiments to evaluate a request received over a network connection to determine which of multiple handler processes shall handle the request.

FIG. 5A is an illustrative flow diagram of first a server side hierarchical cache (‘hcache’) handler task within the process/thread of FIG. 3A that runs on each proxy server in accordance with some embodiments.

FIG. 5B is an illustrative flow diagram of a second server side hcache handler task within the process/thread of FIG. 3A that runs on each proxy server in accordance with some embodiments.

FIG. 6A is an illustrative flow diagram of first a server side regular cache handler task within the process/thread of FIG. 3A that runs on each proxy server in accordance with some embodiments.

FIG. 6B is an Illustrative flow diagram of a second server side regular cache handler task within the process/thread of FIG. 3A that runs on each proxy server in accordance with some embodiments.

FIG. 7A is an illustrative flow diagram of first a server side DSA handler task the process/thread of FIG. 3A that runs on each proxy server in accordance with some embodiments.

FIG. 7B is an Illustrative flow diagram of a second server side DSA handler task within the process/thread of FIG. 3A that runs on each proxy server in accordance with some embodiments.

FIG. 8 is an illustrative flow diagram of an error handler task within the process/thread of FIG. 3A that runs on each proxy server in accordance with some embodiments.

FIG. 9 is an illustrative flow diagram of client task within the process/thread of FIG. 3A that runs on each proxy server in accordance with some embodiments.

FIG. 10 is an illustrative flow diagram representing a process to asynchronously read and write data to SSL network connections in the NIO layer in accordance with some embodiments.

FIGS. 11A-11C are illustrative drawings representing a process to create (FIG. 11A) a cache key; and a process to (FIG. 11B) to associate content represented by a cache key with a root server; and a process (FIG. 11C) to use the cache key to manage regular and hierarchical caching.

FIG. 12 is an illustrative drawing representing the architecture of software running within a proxy server in accordance with some embodiments.

FIG. 13 is an illustrative flow diagram showing a non-blocking process for reading a block of data from a device.

FIG. 14 is an illustrative drawing functionally representing a virtual “tunnel” of data used to deliver data read from one device to be written to another device that can be created by a higher level application using the NIO framework.

FIG. 15 is an illustrative drawing showing additional details of the architecture of software running within a proxy server in accordance with some embodiments.

FIG. 16 is an illustrative drawing showing details of the custom object framework that is incorporated within the architecture of FIG. 15 running within a proxy server in accordance with some embodiments.

FIG. 17 is an illustrative drawing showing details of a custom object that runs within a sandbox environment within the custom object framework of FIG. 16 in accordance with some embodiments.

FIG. 18 is an illustrative flow diagram that illustrates the flow of a request, as it arrives from an end-user's user-agent in accordance with some embodiments.

FIG. 19 is an illustrative flow diagram to show deployment of new custom object code in accordance with some embodiments.

FIG. 20 is an illustrative flow diagram of overall CDN flow according to FIGS. 4-9 in accordance with some embodiments.

FIG. 21 is an illustrative flow diagram of a custom object process flow in accordance with some embodiments.

FIGS. 22A-22B are illustrative drawings showing an example of an operation by custom object running within the flow of FIG. 21 that is blocking

FIG. 23 is an illustrative flow diagram that provides some examples to potentially blocking services that the custom object may request in accordance with some embodiments.

FIG. 24 shows an illustrative example configuration file in accordance with some embodiments.

FIGS. 25A-25B show another illustrative example configuration file in accordance with some embodiments.

FIG. 26 is an illustrative block level diagram of a computer system that can be programmed to act as a proxy server that configured to implement the processes.

### DESCRIPTION OF THE EMBODIMENTS

The following description is presented to enable any person skilled in the art to make and use a computer implemented system and method and article of manufacture to perform content delivery over a network, especially the internet, in accordance with the invention, and is provided in the context of particular embodiments, applications and their requirements. Various modifications to the disclosed embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and processes are shown in block diagram form in order not to obscure the description of the invention with unnecessary detail. Thus, the present invention is not intended to be limited to the embodiments shown, but is to be accorded the widest scope consistent with the principles and features disclosed herein.

Hierarchical Cache

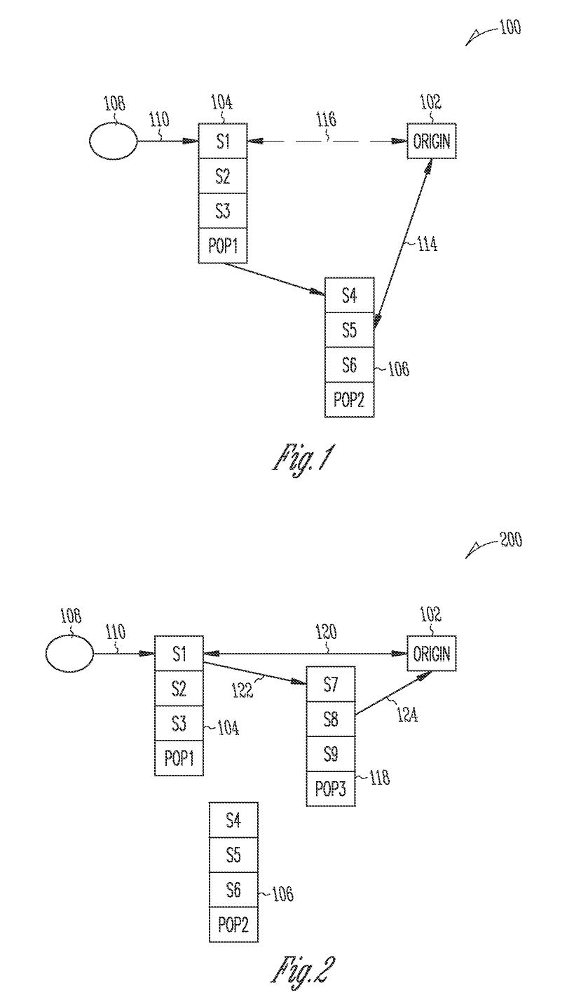

FIG. 1 is an illustrative architecture level drawing to show the relationships among servers in a hierarchical cache 100 in accordance with some embodiments. An origin 102, which may in fact comprise a plurality of servers, acts as the original source of cacheable content. The origin 102, for example, may belong to an eCommerce provider or other online provider of content such as videos, music or news, for example, that utilizes the caching and dynamic site acceleration services provided by a CDN comprising the novel proxy servers described herein. An origin 102 can serve one or more different types of content from one server. Alternatively, an origin 102 for a given provider may distribute content from several different servers—one or more servers for an application, another one or more servers for large files, another one or more servers for images and another one or more servers for SSL, for example. As used herein, the term ‘origin’ shall be used to refer to the source of content served by a provider, whether from a single server or from multiple different servers.

The hierarchical cache 100 includes a first POP (point of presence) 104 and a second POP 106. Each POP 104, 106 may comprise a plurality (or cluster) of proxy servers. Simply stated, a ‘proxy server’ is a server, which clients use to access other computers. A POP typically will have multiple IP addresses associated with it, some unique to a specific server, and some shared between several servers to form a cluster of servers. An IP address may be assigned to a specific service served from that POP (for instance—serving a specific origin), or could be used to serve multiple services/origins.

A client ordinarily connects to a proxy server to request some service, such as a file, connection, web page, or other resource, that is available on another server (e.g., a caching proxy or the origin). The proxy server receiving the request then may go directly to that other server (or to another intermediate proxy server) and request what the client wants on behalf of the client. Note that a typical proxy server has both client functionality and a server functionality, and as such, a proxy server that makes a request to another server (caching, origin or intermediate) acts as a client relative to that other server.

The first POP (point of presence) 104 comprises a first plurality (or cluster) of proxy servers S1, S2, and S3 used to cache content previously served from the origin 102. The first POP 104 is referred to as a ‘last mile’ POP to indicate that it is located relatively close to the end user device 108 in terms of network “distance”, not necessarily geographically so as to best serve the end user according to the network topology. A second POP 106 comprises a second plurality (or cluster) of proxy servers S4, S5 and S6 used to cache content previously served from the origin 102. The cluster shares an IP address to serve this origin 102. The cluster within the second POP 106 may have additional IP addresses also. Each of proxy servers S1, S2 and S3 is configured on a different machine. Likewise, each of proxy servers S4, S5 and S6 is configured on a different machine. Moreover, each of these servers run the same computer program code (software) encoded in a computer readable storage device described below, albeit with different configuration information to reflect their different topological locations within the network.

In a cache hierarchy according to some embodiments, content is assigned to a ‘root’ server to cache that content. Root server designations are made on a content basis meaning that each content object is assigned to a root server. In this manner, content objects are allocated among a cluster of proxies. A given proxy within a cluster may serve as the root for thousands of content objects. The root server for a given content object acts as the proxy that will access the origin 102 to get the given content object if that object has not been cached on that root or if it has expired

In operation, for example, an end user device 108 creates a first network connection 110 to proxy server S1 and makes a request over the first connection 110 for some specific cacheable content, a photo image for instance. The proxy server to which the end user device 108 connects is referred to as a ‘front server’. S1 acts as the front server in this example. In response to the user device request, S1 determines in the case of hierarchical caching, whether it is designated to cache the requested content. If S1 determines that it was designated to cache this content (i.e. whether it is a ‘root server’ for this content). If S1 is the root server for this content, then it determines whether in fact it has cached the requested content. If S1 determines that it has cached the requested content, then S1 will verify that the cached content is ‘fresh’ (i.e. has not expired). If the content has been cached and is fresh then S1 serves the requested content to the end user device 108 over the first connection 110. If the content is not cached or not fresh, then Si checks for the content on a secondary root server. If the content is not cached or not fresh on the secondary root, then S1 checks for the content on the origin 102 or on the second (shielding) POP 106, if this content was determined to be served using shielding-hierarchical cache. When S1 receives the content and verifies that it is good, it will serve it to the end user device 108.

If instead S1 determines that it is not the root for that request, then S1 based on the request will determine which server should cache this requested content (i.e. which is the ‘root server’ for the content). Assume now instead that S1 determines that S2 is the root server for the requested content. In that case, S1 sends a request to S2 to get the content from S2. Typically, S1 sends a request to S2 requesting the content. If S2 determines that it has cached the requested content, then S2 will determine whether the content is fresh and not expired. If the content is fresh then S2 serves the requested content back to S1 (on the same connection), and S1 in turn serves the requested content to the end user device 108 over the first connection 110. Note that in this case, S1 will not store the object in cache, as it is stored on S2. If S2 determines that it has not cached the requested content, then S2 will check if there is a secondary ‘root server’ for this content.

Assume now that S3 acts such a secondary root for the sought after content. S2 then sends a request to S3 requesting the content. If S3 determines that it has cached the requested content and that it is fresh, then S3 serves the requested content to S2, and S2 will store this content in cache (as it is supposed to cache it) and will serve it back to S1. S1 in turn serves the requested content to the end user device 108 over the first connection 110.

On the other hand, if S3 determines that it has not cached the requested content, then S3 informs S2 of a cache miss at S3, and S2 determines if a second/shielding POP 106 is defined for that object or not. If no second POP 106 is defined, then S2 will access the origin 102 over connection 116 to obtain the content. On the other hand, if a second/shielding POP 106 is defined for that content, then S2 sends a request to the second/shielding POP 106.

More particularly, assuming that a second/shielding POP 106 exists, S2 creates a network connection 112 with the cluster serving the origin in the second POP 106, or uses an existing such connection if already in place and available. For example, S2 may select from among a connection pool (not shown) for a previously created connection with a server serving the origin from within the second POP 106. If no such previous connection exists, then a new connection is created. Assuming that the second connection 112 has been created between S1 of the first POP 104 and S4 of the second POP 106, then a process similar to that described above with reference to the first POP 104 is used to determine whether any of S4, S5 and S6 have cached the requested content. Specifically, for example, S4 determines which server is the root in POP 106 for the requested content. If it finds that S5 is the root, then S4 sends a request to S5 requesting the content from S5. If S5 has cached the content and the cached content is fresh, then S5 serves the requested content to S4, which serves it back to S2, which in turn serves the content back to S1. S2 also caches content since S2 is assumed in this example to be a root for this content. S1 serves the requested content to the end user device 108 over the first connection 110. If on the other hand, S5 has not cached the requested content or the content is not fresh, then S5 sends a request over a third network connection 114 to the origin 102. S5 may select the third connection 114 from among previously created connections within a connection pool (not shown) or if no previous connection between S5 and the static content origin 102 exists, then a new third network connection 114 is created.

The origin 102 returns the requested content to S5 over the third connection 114. S5 inspects the response from the origin 102 and determines whether the response/content is cacheable based on the response header; non-cacheable content will indicate in the header that it should not be cached. If returned content is non-cacheable, then S5 will not store it and will deliver it back with the appropriate instructions (so that S2 will not cache it either). If the returned content is cacheable then it will be stored with the caching parameters. If the content already was in cached (i.e. the requested content was not modified) but was registered as expired—then the record associated with the cached content is updated to indicate a new expiration time. S5 sends the requested content to S4, which in turn sends it over the second connection 112 to S2, which in turn sends it to S1, which in turn sends it to the end user device 108. Assuming that the content is determined to be cacheable, then both S2 and S5 cache the returned content object.

In some embodiments, in accordance with the HTTP protocol, when a content object is in cache but listed as expired, a server may actually request the object with an “if modified since” or similar indication of what object it has in cache. The server (origin or secondary server) may verify that the cached object is still fresh, and will reply with a “not modified” response—notifying that the copy is still fresh and that it can be used.

The second POP 106 may be referred to as a secondary or ‘shielding’ POP 106, which provides a secondary level of hierarchical cache. Typically, a secondary POP can be secondary to multiple POPs. As such it increases the probability that it will have a given content object in cache. Moreover, it provides redundancy. If a front POP fails, the content is still cached in a close location. A secondary POP also reduces the load on the origin 102. Furthermore, if a POP fails, the secondary POP, rather than the origin 102 may absorb the brunt of the failover hit.

In some embodiments, no second/shielding POP 106 is provided. In that case, in the event of cache misses by the root server for the requested content, the root server will access the origin 102 to obtain the content.

Dynamic Site Acceleration (DSA)

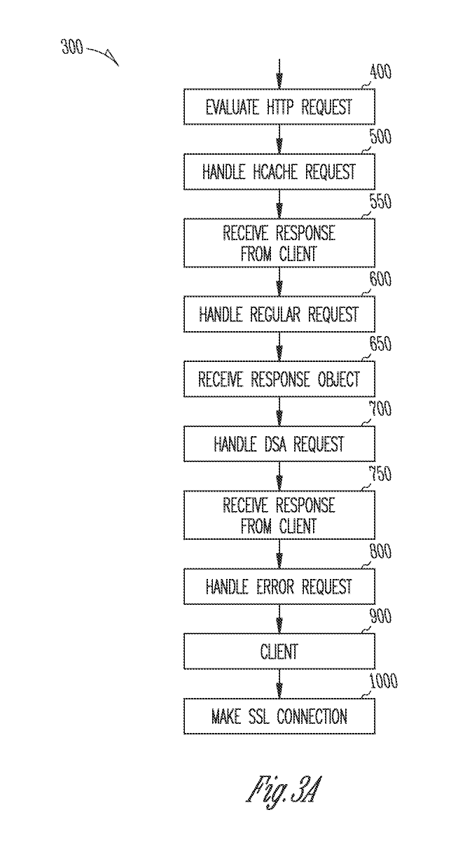

FIG. 2 is an illustrative architecture level drawing to show the relationships among servers in two different dynamic site acceleration (DSA) configurations 200 in accordance with some embodiments. Items in FIGS. 1-2 that are identical are labeled with identical reference numerals. The same origin 102 may serve both static and dynamic content, although the delivery of static and dynamic content may be separated into different servers within the origin 102. It will be appreciated from the drawings that the proxy servers S1, S2 and S3 of the first POP 104 that act as servers in the hierarchical cache of FIG. 1 also act as servers in the DSA configuration of FIG. 2. A third POP 118 comprises a third plurality (or cluster) of proxy servers S7, S8, and S9 used to request dynamic content from the dynamic content origin 102. The cluster of servers in the third POP 118 may share an IP address for a specific service (serving the origin 102), but an IP address may be used for more than one service in some cases. The third POP 118 is referred to as a ‘first mile’ POP to indicate that it is located relatively close to the origin 102 (close in terms of network distance). Note that the second POP 106 does not participate in DSA in this example configuration.

The illustrative drawing of FIG. 2 actually shows two alternative DSA configurations, an asymmetric DSA configuration involving fifth network connection 120 and a symmetric DSA configuration involving sixth and seventh network connections 122 and 124. The asymmetric DSA configuration includes the first (i.e. ‘last mile’) POP 104 located relatively close to the end user device 108, but it does not include a ‘first mile’ POP that is relatively close to the origin 102. In contrast, the symmetric DSA configuration includes both the first (i.e. ‘last mile’) POP 104 located relatively close to the end user device 108 and the third (‘first mile’) POP 118 that is located relatively close to the dynamic content origin 102.

Assume for example, that the user device 108 makes a request for dynamic content such as login information to perform transaction purchase online, or to obtain web based email, for example, over the first network connection 110. In the asymmetric DSA configuration, the front server S1 uses the fifth network connection 120 to request the dynamic content directly from the origin 102. Whereas, in the symmetric configuration, the front server S1 uses the sixth network connection 122 to request the dynamic content from a server, e.g. S7, within the third POP 118, which in turn, uses the seventh connection 124 to request the dynamic content from the origin 102. In some embodiments—to optimize the connection and delivery efficiency, all connections to a specific origin will be done from a specific server in the POP (or a limited list of servers in the POP). In that case—the server S1 will request the specific “chosen” server in the first POP 104 to get the content from the origin in the asynchronous mode. Server S7 acts in a similar manner within the first mile POP 118. This is relevant mostly when accessing the origin 102.

In the asymmetric DSA configuration, the (front) server S1 may select the fifth connection 120 from among a connection pool (not shown), but if no such connection with the dynamic origin 102 exists in the pool, then S1 creates a new fifth connection 120 with the dynamic content origin 102. In contrast, in the symmetric configuration, (front) server S1 may select the sixth connection 122 from among a connection pool (not shown), but if no such connection with the third POP 118, then S1 creates a new sixth connection 122 with a server within the third POP 118.

In DSA, all the three connections described above will be persistent. Once they are set up, they typically will be kept open with ‘HTTP keep alive’, for example, and all requests going from one of the servers to the origin 102, or to the another POP will be pooled on these connections. An advantage of maintaining a persistent connection is that the connection will be kept in an optimal condition to carry traffic so that a request using such connection will be fast and optimized: (1) No need to initiate a connection—as it is live (initiation of a connection typically will take one or two round trips in the case of TCP, and several round trips just for the key exchange in the case of setting up an SSL connection); (2) The TCP congestion window will typically reach the optimal settings for the specific connection, so the content on it will flow faster. Accordingly, in DSA it is generally desirable to keep the connections as busy as possible, carrying more traffic, to keep them in an optimized condition.

In operation, neither the asymmetric DSA configuration nor the symmetric DSA configuration caches the dynamic content served by the origin 102. In the asymmetric DSA configuration, the dynamic content is served on the fifth connection 120 from the dynamic content origin 102 to the (‘last mile’) first POP 104 and then on the first connection 110 to the end user. In the symmetric DSA configuration, the dynamic content is served on the seventh connection 124 from the dynamic content origin 102 to the (‘first mile’) third POP 118, and then on the sixth connection 122 from the third POP 118 to the (‘last mile’) first POP 104, and then on the first connection 110 from the first POP 104 to the end user device 108.

Several tradeoffs may be considered when deciding whether to employ asymmetric DSA or symmetric DSA. For example, when the connection between the origin 102 and a last mile POP 104 is efficient, with low (or non) packet loss, and with a stable latency—asymmetric DSA will be good enough, or even better, as it will reduce an additional hop/proxy server on the way, and will be cheaper to implement (less resources consumed). On the other hand, for example, when the connection from the origin 102 to the last mile POP 104 is congested, not stable, with variable bit-rate, error-rate and latency—a symmetric DSA may be preferred, so that the connection from the origin 102 will be efficient (due to low roundtrip time and better peering).

Thread/Process with Multiple Tasks

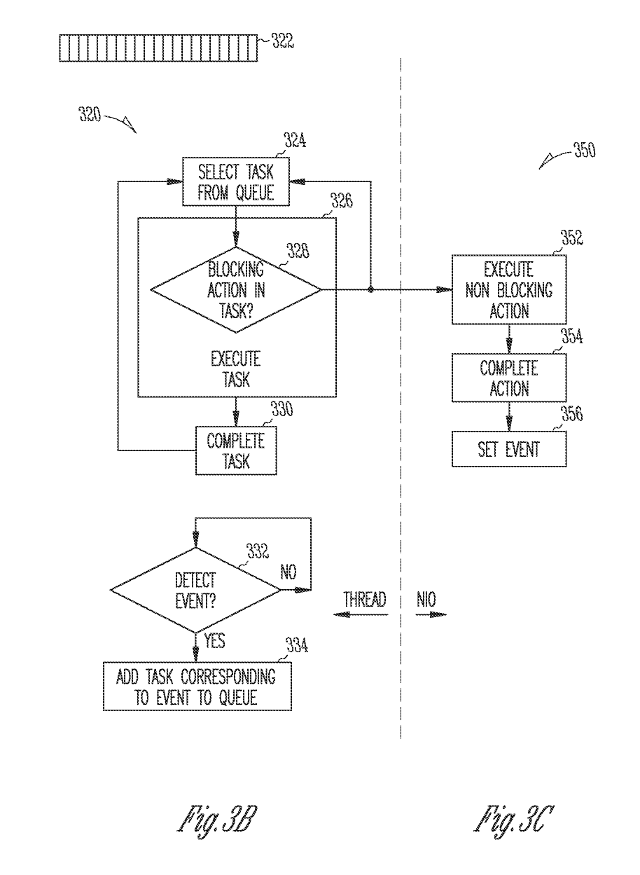

FIG. 3A is an illustrative drawing of a process/thread 300 that runs on each of the proxy servers in accordance with some embodiments. The thread comprises a plurality of tasks described below. Each task can be run asynchronously by the same process/thread 300. These tasks run in the same process/thread 300 to optimize memory and CPU usage. The process/thread 300 switches between the tasks based on availability of the resources that the tasks may require, performing each task in an asynchronous manner (i.e.—executing the different segments until a “blocking” action), and then switching to the next task. The process/thread is encoded in computer readable storage device to configure a proxy server to perform the tasks. An underlying NIO layer also encoded in a computer readable device manages accessing information from the network or from storage that may cause individual tasks to block, and providing a framework for the thread 300 to work in such an asynchronous non-blocking mode as mentioned above, by checking the availability of the potentially blocking resources, and providing non-blocking functions and calls for threads such as 300, so that they can operate optimally. Each arriving request will trigger such an event, and a thread like 300 will handle all the requests as ordered (by order of request, or resource availability). The list of tasks can be managed in a data-structure for 300 to use (for example, a queue). To support such an implementation each server task, the potentially may have many blocking calls in it, will be re-written as a set of non-blocking modules, that together will complete the task, however, each one of these tasks can be executed uninterruptedly, and these modules can be executed asynchronously, and mixed with modules of other tasks.

FIGS. 3B-3C are an illustrative set of flow diagrams that show additional details of the operation of the thread 320 (FIG. 3B) and its interaction with an asynchronous IO layer 350 (FIG. 3C) referred to as NIO. The processes of FIGS. 3B-3C represent computer program processes that configure a machine to perform the illustrated operations. Whenever a new socket connection or HTTP request is received, for example, a task is added to a queue 322 of non blocking tasks ready to be executed. Thread module 324 monitors the queue 322 of non blocking tasks awaiting execution and selects tasks from the queue for execution. Thread module 326 executes the selected task. Task module 328 determines when a potentially blocking action is to be executed within the task. If no non blocking action occurs within the task, then in thread module 330 completes the task and passes back to thread module 324 to select another task for execution. However if module 328 determines that a potentially blocking action is to be executed, a call is made to an NIO layer module 352 to execute the action in a non blocking way (i.e. in a way that does not block other tasks), and control within the thread 320 passes back to module 324, which selects another task from the queue 322 for execution. Referring again to the NIO side, when the blocking action is completed (e.g., a sought after resource is available—e.g., content or connection), NIO layer module 354 triggers an event 356. The thread module 332 detects the event, and thread module 334 adds the previously blocked task to the queue once again so that the thread can select it to complete execution where it left off before.

Tasks

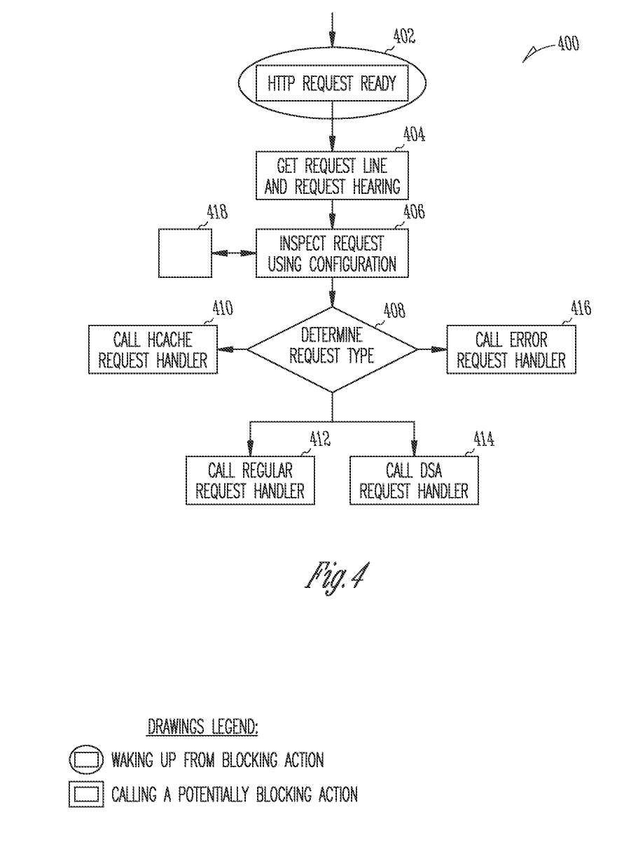

FIG. 4 is an illustrative flow diagram representing an application level task 400 within the process/thread 400 that runs on a proxy server in accordance with some embodiments to evaluate a request received over a network connection to determine which of multiple handler processes shall handle the request. Each of the servers 104, 106 and 118 of FIGS. 1-2 can run one or more instances of the thread that includes the task 400. In accordance with some embodiments, one process/thread or a small number of process/threads are run that include the task 400 of evaluating requests to ensure optimal usage of the resources. When an evaluation of one request, i.e. one evaluation request/task, is blocking, the same process can continue and handle different tasks within the thread, returning to the blocking task when the data or device will be ready.

It will be appreciated that a request may be sent by one of the servers to another server or from the user device 108 to the front server 104. In some embodiments, the request comprises an HTTP request received over a TCP/IP connection. The flow diagram of FIG. 3A includes a plurality of modules 402-416 that represent the configuring of proxy server processing resources (e.g. processors, memory, storage) according to machine readable program code stored in a machine readable storage device to perform specified acts of the modules. The process utilizes information within a configuration structure 418 encoded in a memory device to select a handler process to handle the request.

Module 402 acts to receive notification that a request, or at least a require portion of the request, is stored in memory and is ready to be processed. More specifically, a thread described below listens on a TCP/IP connection between the proxy server receiving the request and a ‘client’ to monitor the receipt of the request over the network. Persons skilled in the art will appreciate that a proxy server includes both a server side interface that serves (i.e. responds to) requests including requests from other proxy servers and a client side interface that makes (i.e. sends) requests including requests to other proxy servers. Thus, the client on the TCP/IP connection monitored by the NIO layer may be an end user device or the client side of another proxy server.

Module 402 in essence wakes up upon receipt of notification from the NIO layer that a sufficient portion of a request has arrived in memory to begin to evaluate the request. The process 400 is non-blocking. Instead of the process/thread that includes task 400 being blocked until the action of module 402 is completed, the call for this action will return immediately, with an indication of failure (as the action is not completed). This enables the process/task to perform other tasks (e.g. to evaluate other HTTP requests or some different task) in the meantime, returning to the task of determining whether the particular HTTP request is ready when the NIO layer indicates that the resources are in memory and ready to continue with that task.

While an instance of process 400 waits for notification from the NIO layer that sufficient information has arrived on the connection and has been loaded to memory, other application level processes, including other instances of process 400 can run on the proxy server. Assuming that the request comprises an HTTP request, in accordance with some embodiments, only the HTTP request line and the HTTP request header need to have been loaded into memory in order to prompt the wake up notification by the NIO layer. The request body need not be in memory. Moreover, in some embodiments, the NIO layer ensures that the HTTP request body is not loaded to memory before the process 400 evaluates the request to determine which handler should handle the request.

By limiting the amount of information from the request required to be loaded to memory in order to process the request, the amount of memory utilized by the process 400 is minimized. By limiting the request processing to involve only certain portions of the request, the memory usage requirements of the process 400 are minimized leaving more memory space available for other tasks/requests including other instance of process 400.

By utilizing the NIO layer, which runs on the TCP/IP connection, to monitor the connection, if it is observed (by the operating system and the NIO layer) that the process 400 can become blocked, NIO layer will indicate to the calling task that it cannot be completed yet, and the NIO layer will work on completing it (reading or writing the required data). In this way, the process can perform other tasks (evaluate other requests) in the meantime, and wait for notification from the NIO layer that adequate request information is in memory to proceed. In the meantime, the process can perform other tasks including other instances of 400, which are unblocked. Again, as explained above, thousands or tens of thousands of other application level tasks including other instances of task 400 may simultaneously be executed on the proxy server by a single thread (or just a few threads), due to this implementation, and since the task 400 is implemented in an asynchronous non-blocking method, these other tasks or instances are not delayed while the request information for a given task 400 is received and stored in memory.

In response to the wake up of module 402, module 404 obtains the HTTP request line and the HTTP header from memory. Module 406 inspects the request information and checks the host name, which is part of the HTTP header, to verify that the host is supported (i.e. served on this proxy server). In some embodiments, the host name and the URL from the request line are used as described below to create a key for the cache/request. Alternatively, however, such key may be created using some more parameters from the header (such as a specific cookie, user-agent, or other data such as the client's IP, which typically is received from the connection. Other parameters from the header that may be relevant to assembling a response to the request include: supported file formats, support of compression, user-agent (indicates the browser/platform of the client). Also, an HTTP header may provide data regarding the requested content object, in case it is already cached on the client (e.g., from previous requests).

Decision module 408 uses information parameters from the request identified by module 406 to determine which handler process to employ to service the request. More particularly, the configuration structure 418 contains configuration information used by the decision module 408 to filter the request information identified by module 406 to determine how to process the request. The decision module 408 performs a matching of selected request information against configuration information within configuration structure 418 and determines which handler process to use based upon a closest match.

A filter function is defined based upon the values of parameters from the HTTP request line and header described above, primarily the URL. Specifically, the configuration structure (or file) defines combinations of parameters referred to as ‘views’. The decision module 418 compares selected portions of the HTTP request information with views and selects the handler process to use based upon a best match between the HTTP request information and the views from the configuration structure 418.

The views defined within the configuration structure, which comprises a set of conditions on the resources/data processed from the header and request line, as well as connection parameters (such as the requesting client's IP address or the server's IP address used for this request (the server may have multiple IP addresses configured). These conditions are formed into “filters” and kept in a data structure in memory. When receiving a request the server will process the request data, and match it to the set of filters/conditions to determine which of the views best matches the request.

The following Table 1 sets forth hypothetical example views and corresponding handler selections. If the HTTP request parameters match the filter view then a corresponding handler is selected as indicated in Table 1. Please revert the order of the columns—“filter view” should be the first (to the left) and the “selected handler” should be the middle column. The “key” to the rule is the filter, not the handler, as the filter will determine which handler to use.

TABLE 1

| | | Additional Processing |
|---|---|---|
| Filter view | Selected handler | Requirements |
| Default | DSA handler | not to cache (no-store) |
| URLs of the form *.jpg, | Hierarchical | cached for 7 days, and |
| *.gif, *.flv, *.js, *.css | cache handler | to be fetched with no |
| | | encryption (no SSL) |
| URLs of the form/search* | DSA | non cacheable (no-store) |
| URLs of the form/ | Regular | cache for 5 hours |
| search/*.jpg, /search/*.flv | request handler | |
| specific IP range | Error | Block |
| user-agent is within a | DSA | don't cache, fetch |
| specific list | | from alternative origin |
| request is for a specific | Error | Block |
| path (/forbidden/* | | |

Also, refer to the attached appendix for a further explanation of a configuration file in a computer program code format in accordance with some embodiments.

Depending upon the results of filtering of HTTP request parameters by decision module 408, process 400 branches to a call to one of hierarchical cache (hcache) handler of module 410, ‘regular’ request handler of module 412, DSA request handler of module 414 or error request handler 416 of module 416. Each of these handlers is described below. A regular request is a request that will be cached, but not in a hierarchical manner; it involves neither DSA nor not hierarchical caching.

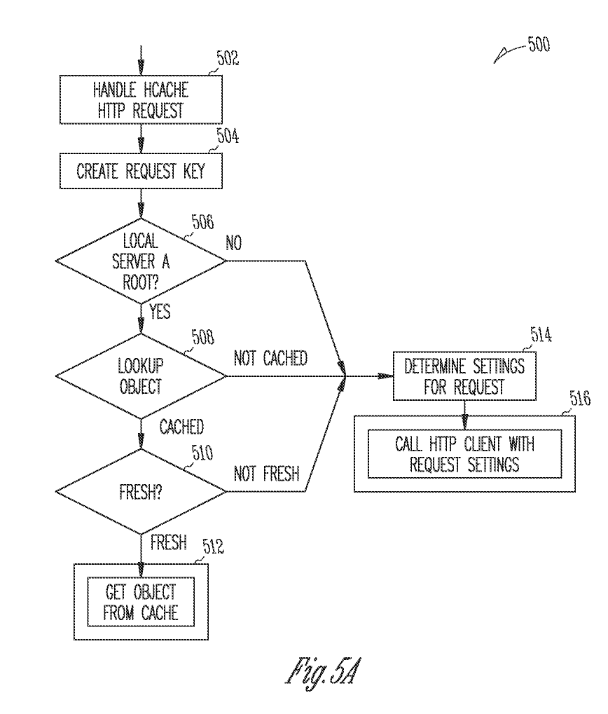

FIG. 5A is an illustrative flow diagram of first a server side hierarchical cache (‘hcache’) handler task 500 that runs on each proxy server in accordance with some embodiments. FIG. 5B is an illustrative flow diagram of a second server side hcache handler task 550 that runs on each proxy server in accordance with some embodiments. The tasks of FIGS. 5A-54B are implemented using computer program code that configures proxy server resources e.g., processors, memory and storage to perform the acts specified by the various modules shown in the diagrams.

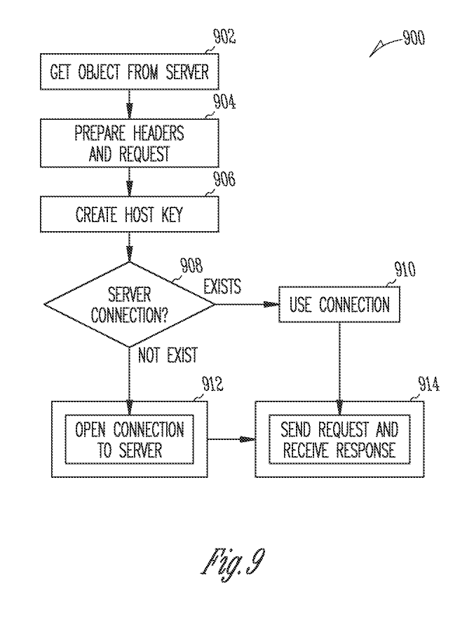

Referring to FIGS. 4 and 5A, assuming that the request task 400 of FIG. 4 determines that the hierarchical cache handler 410 corresponding to module 410 should process a given HTTP request, module 502 of FIG. 5A wakes up to initiate processing of the HTTP request. Module 504 involves generation of a request key associated with the cache request. Request key generation is explained below with reference to FIGS. 11A-11C. Based upon the request key, decision module 506 determines whether the proxy server that received the request is the root server for the requested content (i.e. IO device, in one of many ways, for instance, it could be stored directly on a disk, stored as a file in a filesystem, or other. Note that as an object could be potentially very large, only a portion of it can be stored in memory, and on each time a portion will be handled, after which fetching the next block.

Module 512 involves a potentially blocking action since there may be significant latency between the time that the object is requested and the time it is returned. Module 512 makes a non-blocking call to NIO layer or the content object. The NIO layer in turn may set an event to notify of when some prescribed block of data from the object had been loaded into memory. The module 512 is at that point terminated, and will resume when the NIO layer notifies that a prescribed block of data from the requested object has been loaded into memory and is ready to be read. At that point the module can resume and read the block of data (as it is in memory) and will deliver the block to a sender procedure to prepare the data and sent it to the requesting client (e.g. a user device or another proxy server). This process will repeat until the entire object was processed and sent to the requestor, i.e. fetching a block asynchronously to memory, sending it to the requestor and so forth. Note that when the module waits for a blocking resource to be available, due to the non-blocking asynchronous implementation, the process can in fact handle other tasks, requests or responses, while keeping the state of each such “separated” task as it was broken to a set of non blocking segments. As explained below—a layer such as the NIO utilizing a poller (such as epoll) enables a single thread/process to handle many simultaneous tasks, each implemented in a manner as described above, using a single call to wait for multiple events/blocking operations/devices. Handling multiple tasks in a single thread/process, as opposed to managing each task in a separate thread/process results in a much more efficient overall server, and a much better memory, IO and CPU utilization.

If decision module 506 determines that the current proxy is not the root or if module 508 determines that the proxy has not cached, the content or decision process 510 determines that the content is not fresh then control flows to module 514. Based on the flow of the request—the next server is determined according to the following logic, as described in FIG. 1. Note that each hop (server) on the path of the request will add an internal header indicating the path of the request (this is also important for logging and billing reasons—as you want to log the request only once in the system). This way loops can be avoided, and each server is aware of the current flow of the request, and its order in it:
if server is not root—will call the root for content. Only if root is not responsive it will call a secondary root, or otherwise the origin directly. Note that the root server, when asked, if it doesn't have the content will get it, thus eliminating the need from the front server to go to an alternative source.
if server is root—and doesn't have the content cached—it will request from a secondary root in the same POP (this will also happen when the root get a request from another server).
A secondary root—knowing due to the flow sequence that it is the second—will directly go to the origin.
When hierarchical cache shielding method is used, the root server if the content is not cached, or if it determines that it is not fresh, will send a request to the configured shielding POP, instead to the origin.
When a request gets to a shielding POP (from a front POP)—the server handling that is aware it is acting as a shielding server for this request (due to the flow sequence of the handling of this request as indicated in the headers), thus will act just like a regular hcache POP (i.e., in case the content is not found in the POP it will go and get it from the origin).

The settings therefore set forth in prioritized or hierarchical set of servers from which to seek the content. Module 514 uses these settings to identify the next server. The settings can be defined, for example, for an origin (customer), or for a specific view for that origin. Due to the fact that a CDN network is globally distributes, the actual servers and “next server” for DSA and hcache or shielding hcache, are different in each POP. The shielding POP will be configured typically by the CDN provider for each POP, and the customer can simply indicate that he wants this feature. Defining the exact address of the next server could be determined by a DNS query (where a dedicated service provided by the CDN will resolve the DNS query based on the server/location from which it was asked) or using some static configuration. The configurations are distributed between the POPs from a management system in a standard manner, and local configurations specific to a POP will typically be configured when setting the POP up. Note that the configuration will always be in memory to ensure immediate decision (with no IO latency.

Module 514 determines the next server in the cache hierarchy from whom to request the content based upon the settings. Module 516 makes a request to the HTTP client task for the content from the next server in the hierarchy identified settings to have cached the content.

Referring to FIG. 5B, non-blocking module 552 is awakened by the NIO layer when the client side of the proxy receives a response from the next in order hierarchical server. If decision module 554 determines that the next hierarchical cache returned content that was not fresh, then control flows to module 556, which like module 514 uses the cache hierarchy settings for the content to determine the next in order server in the hierarchy from which to seek the content; and module 558 like module 516, calls the HTTP client on the proxy to make a request for the content from the next server in the hierarchy. If decision module 554 determines that there is an error in the information returned by the next higher server in the hierarchy, then control flows to module 560, which calls the error handler. If the decision module 554 determines that fresh content has been returned without errors, then module 562 serves the content to the user device or other proxy server that requested the content from the current server.

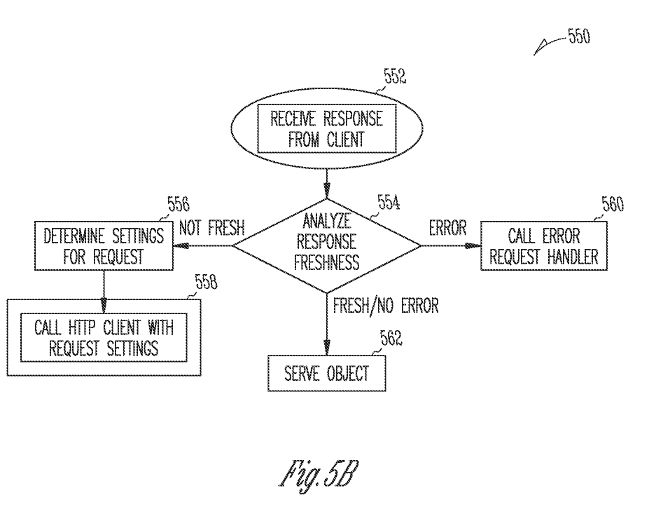

FIG. 6A is an illustrative flow diagram of first a server side regular cache handler task 600 that runs on each proxy server in accordance with some embodiments. FIG. 6B is an Illustrative flow diagram of a second server side regular cache handler task 660 that runs on each proxy server in accordance with some embodiments. The tasks of FIGS. 6A-6B are implemented using computer program code that configures proxy server resources e.g., processors, memory and storage to perform the acts specified by the various modules shown in the diagrams.

Referring to FIGS. 4 and 6A, assuming that the request process 400 of FIG. 4 determines that the regular cache handler corresponding to module 412 should process a given HTTP request, module 602 of FIG. 6A wakes up to initiate processing of the HTTP request. Module 604 involves generation of a request key associated with the cache request. Based upon the request key, decision module 608 performs a lookup for the requested object. Assuming that the lookup determines that the requested object actually is cached on the current proxy server, decision module 610 determines whether the cached content object is ‘fresh’ (i.e., not expired).

If decision module 608 determines that the proxy has not cached the content or decision process 610 determines that the content is not fresh, then control flows to module 614. Origin settings are provided that identify for the origin associated with the sought after content. Module 614 uses these settings to identify the origin for the content. Module 616 calls the HTTP client on the current proxy to have it make a request for the content from the origin.

Referring to FIG. 6B, non-blocking module 652 is awakened by the NIO layer when the client side of the proxy receives a response from the origin. Module 654 analyzes the response received from the origin. If decision module 654 determines that there is an error in the information returned by the origin, then control flows to module 660, which calls the error handler. If the decision module 654 determines that the content has been returned without errors, then module 662 serves the content to the user device or other proxy server that requested the content from the current server.

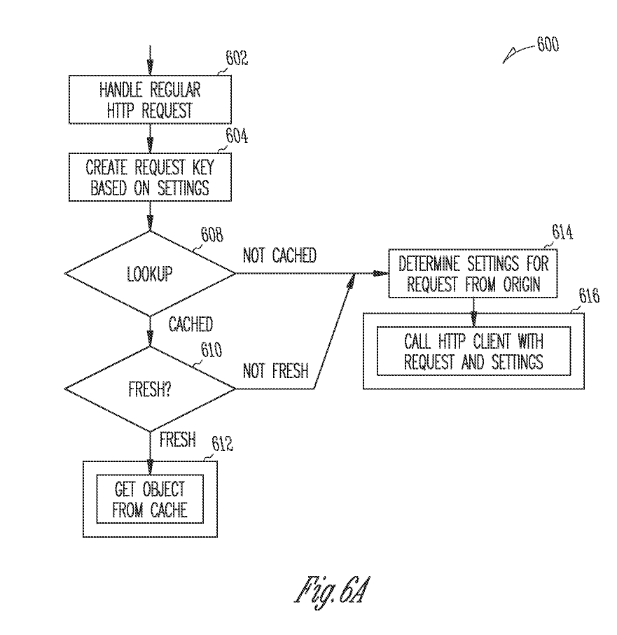

FIG. 7A is an illustrative flow diagram of first a server side DSA handler process 700 that runs on each proxy server in accordance with some embodiments. FIG. 7B is an Illustrative flow diagram of a second server side DSA handler process 450 that runs on each proxy server in accordance with some embodiments. The processes of FIGS. 7A-7B are implemented using computer program code that configures proxy server resources e.g., processors, memory and storage to perform the acts specified by the various modules shown in the diagrams.

Referring to FIGS. 4 and 7A, assuming that the request task 400 of FIG. 4 determines that the DSA handler corresponding to module 414 should process a given HTTP request, module 702 of FIG. 7A receives the HTTP. Module 704 involves determines settings for a request to the origin corresponding to the requested dynamic content. These settings may include next hop server details (first mile POP or origin), connection parameters indicating the method to access the server (e.g., using SSL or not), SSL parameters if any, request line, and can modify or add lines to the request header, for instance (but not limited to), to indicate that this is asked by a CDN server, the path of the request, parameters describing the user-client (such as original user agent, original user IP, and so on). Other connection parameters may include, for example, outgoing server—this may be used to optimize connection between POPs or between a POP to a specific origin—where it is determined that less connections will yield better performance (in that case only a portion of the participating servers will open a DSA connection to the origin, and the rest will direct the outgoing traffic through them. Module 706 calls the HTTP client on the proxy to have it make a request for the dynamic content from the origin.

Referring to FIG. 7B, non-blocking module 752 is awakened by the NIO layer when the client side of the proxy receives a response from the origin. Module 754 analyzes the response received from the origin. If module 754 determines that the response indicates an error in the information returned by the origin, then control flows to module 670, which calls the error handler. If the module 754 determines that the dynamic content has been returned without errors, then module 762 serves the content to the user device or other proxy server that requested the dynamic content from the current server.

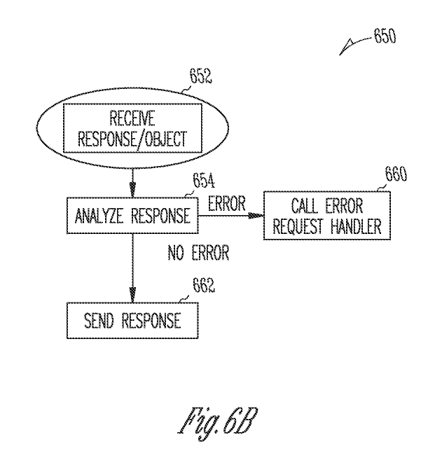

FIG. 8 is an illustrative flow diagram of an error handler task 800 that runs on each proxy server in accordance with some embodiments. The process of FIG. 8 is implemented using computer program code that configures proxy server resources e.g., processors, memory and storage to perform the acts specified by the various modules shown in the diagrams.

Referring to FIGS. 4 and 8, assume that the request task 400 of FIG. 4 determines that the error handler corresponding to module 416 should be called in response to the received HTTP request. Such a call may result from determining that this request should be blocked/restricted based on the configuration (view settings for the customer/origin), request could be not valid (bad format, not supported HTTP version, request for a host which is not configured) or some error on the origin side, for instance, the origin server could be down or not accessible, some internal error may happen in the origin server, origin server could be busy, or other. Module 802 of FIG. 8 wakes up and initiates processing creation of an error response based on the parameters it was given when called (the specific request handler or mapper calling the error handler will provide the reason for the error and how it should be handled based on the configuration). Module 804 determines settings for the error response. Settings may include type of error (terminating the connection or sending a HTTP response with a status code indicating the error), descriptive data about the error to be presented to the user (as content in the response body), status code to be used on the response (for instance, ‘500’ internal server error, ‘403’ forbidden) and specific headers that could be added based on the configuration. Settings will also include data related to the requesting client—as gathered by the request handler, such as HTTP version (so adjusted may be required to send the content to support the specific version), compression support or other information. Module 806 sends the error response to the requesting client, or can terminate the connection to the client if configured/requested to do so, for example.

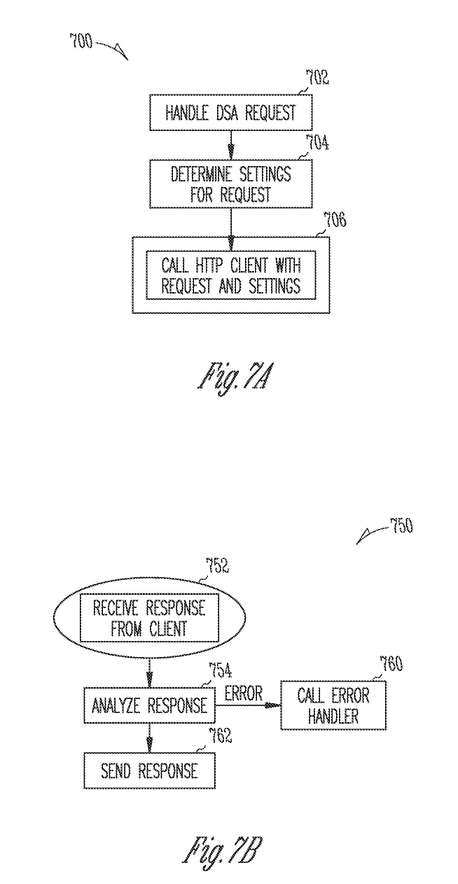

FIG. 9 is an illustrative flow diagram of client task 900 that runs on each proxy server in accordance with some embodiments. The task of FIG. 9 is implemented using computer program code that configures proxy server resources e.g., processors, memory and storage to perform the acts specified by the various modules shown in the diagrams. Module 902 receives a request for a content object from a server side of the proxy on which the client runs. Module 904 prepares headers and a request to be sent to the target server. For instance, the module will use the original received request and will determine based on the configuration if the request line should be modified (for instance—replacing or adding a portion of the URL), modification of the request header may be required—for instance replacing the host line with an alternative host that the next server will expect to see (this will be detailed in the configuration), adding original IP address of the requesting user (if configured to), adding internal headers to track the flow of the request. Module 906 prepares a host key based on the host parameters provided by the server module. The host key is a unique identifier for the host, and will be used to determine if a connection to the required host is already established and can be used to send the request on, or if no such connection exists. Using the host key, decision module 908 determines whether a connection already exists between the proxy on which the client runs and the different proxy or origin server to which the request is to be sent. The proxy on which the client runs may have a pool of connections, and a determination is made as to whether the connection pool includes a connection to the proxy to which a request is to be made for the content object. If decision module 908 determines that a connection already exists, and is available to be used, then module 910 selects the existing connection for use in sending a request for the sought after content. On the other hand, if decision module 908 determines that no connection currently exists between the proxy on which the client runs and the proxy to which the request is to be sent then module 912 will call the NIO layer to establish a new connection between the two, passing all the relevant parameters for that connection creation. Specifically, if the connection should be using SSL, and in the case the connection required is an SSL connection, the verification method to be used to verify the server's key. Module 914 sends the request to and receives a response from the other proxy server over the connection provided by module 910 or 912. Both modules 912 and 914 may involve blocking actions in which calls are made to the NIO layer to manage transfer of information over a network connection. In either case, the NIO layer wakes up the client once the connection is created in the case of module 912 or once the response is received in the case of module 914.

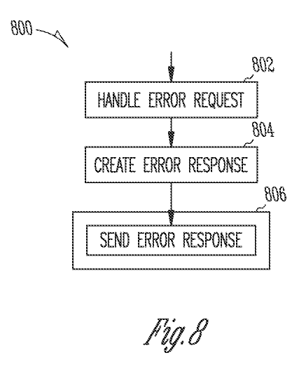

FIG. 10 is an illustrative flow diagram representing a process 1000 to asynchronously read and write data to SSL network connections in the NIO layer in accordance with some embodiments. The flow diagram of FIG. 10 includes a plurality of modules 1002-1022 that represent the configuring of proxy server processing resources (e.g. processors, memory, storage) according to machine readable program code stored in a machine readable storage device to perform specified acts of the modules. Assume that in module 1002 an application is requesting the NIO to send a block of data on an SSL connection. In module 1004, the NIO will then test the state of that SSL connection. If the SSL connection is ready to send data, then in module 1008, NIO will go ahead, will use an encryption key to encrypt the required data, and start sending the encrypted data on the SSL connection. This action can have several results. One possible resulted illustrated through module 1010 is the write returning a failure with a blocked write because the send buffers are full. In that case, as indicated by module 1012, the NIO sets an event and will continue sending the data when the connection is ready. Another possible result indicated by module 1014 is that after sending a portion of the data, the SSL protocol requires some negotiation between the client and the server (for control data, key exchange or other). In that case, as indicated by module 1016, NIO will manage/set up the SSL connection, in the SSL layer. As this action typically involves 2-way network communication between the client and server, any of the read and write actions performed on the TCP socket can be blocking, resulting in a failure to read or write, and the appropriate error (blocked read or write) indicated by module 1018. NIO keeps track on the state of the SSL connection and communication, and as indicated by module 1020, sets an appropriate event, so that when ready, the NIO will continue writing or reading from the socket, to complete the SSL communication. Note that even though the high level application requested to write data (send), the NIO may receive an error for blocked read from the socket. A similar process may take place if in module 1004, NIO detects that the SSL connection needs to be set up, or managed (for instance, if it is not initiated yet, and the two sides need to perform key-exchange in order to start transferring the data), resulting in the NIO progressing first to module 1016 to prepare the SSL connection. Once the connection is ready, NIO can continue (or return) to module 1008 and send the data (or remaining data). Once the entire data is sent, NIO can indicate through module 1022 that the send was completed and send the event to the requesting application.

Keys

FIGS. 11A-11C are illustrative drawings representing process 1100 to create (FIG. 11A) a cache key data 1132 (FIG. 11B); and a process 1130 to associate content represented by a cache key 1132 with a root server; and a process 1150 to use (FIG. 11C) the cache key structure 1130 to manage regular and hierarchical caching.

Referring to FIG. 11A, module 1102 checks a configuration file for the served origin/content provider to determine which information including a host identifier and other information from an HTTP request line is to be used to generate a cache key (or request key). When handling a request, the entire request line and request header are processed, as well as parameters describing the client issuing this request (such as the IP address of the client, or the region from where it comes). The information available to be selected from when defining the key include (but are not limited to):
Host
URL
   Full URL
   Some regular expression on the URL—like path, suffix, prefix.
   A list of components of the URL (for instance—2^{nd} and 4^{th} directories in the path)
User-agent (or a regular expression on it)
A specific cookie
IP address, or region (as received from a geo-IP mapping).

Module 1104 gets the selected set of information identified by module 1102. Module 1106 uses the set of data to create a unique key. For example, in some embodiments, the data is concatenated to one string of characters and an md5 hash function is performed.

Referring to FIG. 11B, there is shown an illustrative drawing of a process to use the cache key 1132 created in the process 1100 of FIG. 11A to associate a root server (server0 . . . serverN-1) with the content corresponding to the key In the event that a content object is determined to be cached in an hierarchical caching method, the proxy will use the cache key created for the content by the process 1100 of FIG. 101 to determine which server in its POPs is the root server for this request. Since the key is a hash of some unique set of parameters, the key can be further used to distribute the content between the participating servers, by using some function to map a hash key to a server. Persons skilled in the art that when using a suitable hash function, for example, the keys can be distributed in a suitable manner such that content will be distributed approximately evenly between the participating servers. Such a mechanism could be, for instance, taking the first 2 bytes of the key. Assume, for example, that the participating servers are numbered from 0 to N-1. In such a case, the span of possible combinations of 2 characters will be split between the servers evenly (for instance—reading the 2 characters as a number X and calculating X mod N, to get a number between 0 and N-1, which will be the server number who caches this content. Note that any other hashing function can be used to distribute keys in a deterministic fashion between a given set of servers.

Referring to the illustrative drawing of FIG. 11C, there is shown a process 1150 to look up an object in a hierarchical cache in accordance with some embodiments. In the case were a given proxy determines that a specific request should be cached on this specific proxy server, that server will use the request key (or cache key) and will look it up in a look-up table 1162 stored fully in memory. The look-up table is indexed using cache keys, so that data about an object is stored in the row indexed by the cache key that was calculated for this object (from the request). The lookup table will contain an exact index of all cached objects on the server. Thus, when the server receives a request and determines that it should cache such a request it will use the cache key as an index to the lookup table, and will check if the required content is actually cached on that proxy server.

NIO Layer

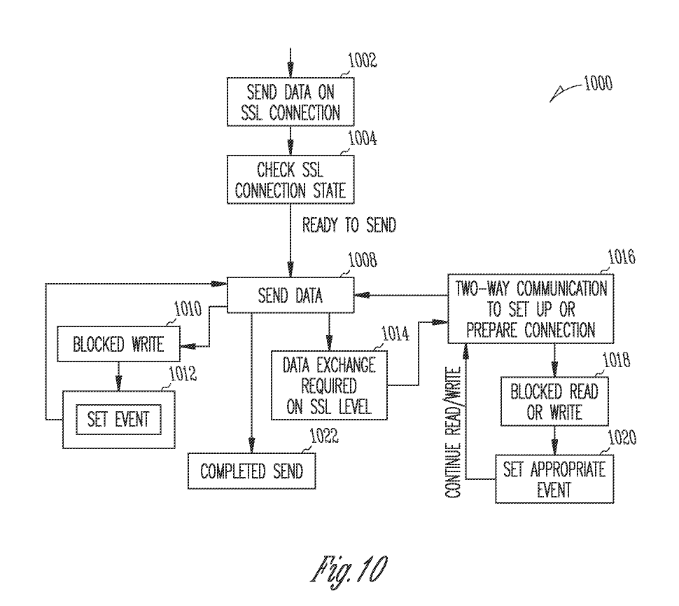

FIG. 12 is an illustrative drawing representing the architecture of software 1200 running within a proxy server in accordance with some embodiments. The software architecture drawing shows relationships between applications 1202-1206, a network IO (NIO) layer 1208 providing asynchronous framework for the applications, an operating system 1210 providing asynchronous and non-blocking system calls, and IO interfaces on this proxy server, namely network connections and interfaces 1212, disk interface 1214 and filesystem access interface 1216. It will be appreciated that there may be other IO interfaces that at are not shown.

Modern operating systems provide non-blocking system calls and operations and provide libraries to poll devices and file descriptors that may have blocking actions. Blocking operations, for example, may request a block of data from some IO device (a disk or network connection for instance). Due to the latency that such an action may present, IO data retrieval may take a long time relative to the CPU speed (e.g., milliseconds to seconds to complete IO operations as compared with sub nanoseconds-long CPU cycles). To prevent inefficient usage of the resources, operating systems will provide non-blocking system calls, so that when performing a potentially blocking action, such as requesting to read a block of data from an IO device, an OS may return the call immediately indicating whether the task completed successfully and if not—will return the status. For instance—when requesting to read a block of 16 KB from a TCP socket, if the read socket buffer had 16 KB of data ready to be read in memory, then the call will succeed immediately. However, if not all data was available, the OS 1210 will provide the partial available data and will return an error indicating the amount of data available and the reason for the failure, for example—blocked read, indicating that the read buffer is empty. An application can then try again reading from the socket, or set an event so that the operating system will send the event to the application when the device (in this case the socket) has data and is available to be read from. Such an event can be set using for instance the epoll library in the Linux operating system. This enables the application to perform other tasks while waiting for the resource to be available.

Similarly when writing a block of data to a device, for example, to a TCP socket, the operation could fail (or be partially performed) due to the fact that the write buffer is full, and the device cannot get additional data at that moment. An event could be set as well, to indicate when the write device is available to be used.

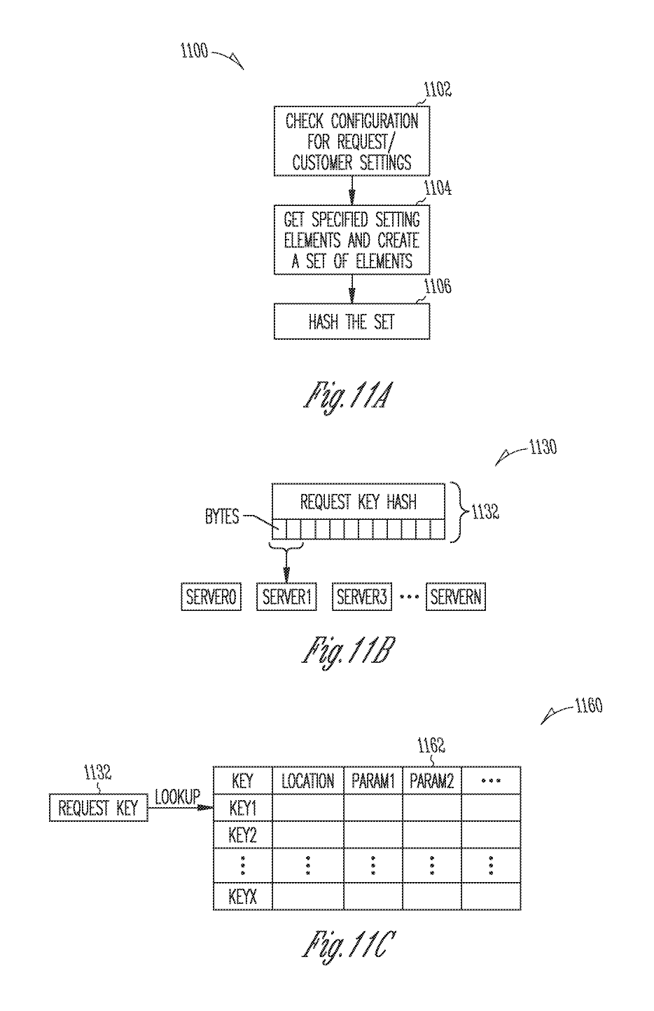

FIG. 13 is an illustrative flow diagram showing a non-blocking process 1300 implemented using the epoll library for reading a block of data from a device. This method could be used by a higher level application 1202-1206 wanting to get a complete asynchronous read of a block of data, and is implemented in the NIO layer 1208, as a layer between the OS 1210 non blocking calls to the applications. Initially, module 1302 (nb_read (dev, n)) makes a non blocking request to read “n” bytes from a device “dev”. The request returns immediately, and the return code can be inspected in decision module 1304, which determines whether the request succeeded. If the request succeeded and the requested data was received, the action is completed and the requested data is available in memory. At that point the NIO framework 1208 through module 1306 can send an indication to the requesting higher level application 1202-1206 that the requested block is available to be read. However, if the request failed, NIO 1208 through module inspects the failure reason. If the reason was due to a blocked-read, NIO 1208 through module 1308 will update the remaining bytes to be read, and will the call an epoll_wait call to the OS, so that the OS 1210 through module 1310 can indicate to the NIO 1208 when the device is ready to be read from. When such an event occurs, NIO 1208 can issue a non blocking read request again, for the remaining bytes, and so forth, until it receives all the requested bytes, which will complete the request. At that point, like above—an event will be sent through block 1306 to the requesting higher level application that the requested data is available.

The NIO 1208, therefore, with the aid of the OS 1210 monitors availability of device resources such as memory (e.g., buffers) or connections that can limit the rate at which data can be transferred and utilizes these resources when they become available. This occurs transparently to the execution of other tasks by the thread. 300/320. More particularly, for example, the NIO layer 1208, therefore, manages actions such as reads or writes involving data transfer over a network connection that may occur incrementally, e.g. data is delivered or sent over a network connection in k-byte chunks. There may be delays between the sending or receiving of the chunks due to TCP window size, for example. The NIO layer handles the incremental sending or receipt of the data while the task requiring the data is blocked and while the thread 300/320 continues to process other tasks on the queue 322 as explained with reference to FIGS. 3B-3C. That is, the NIO layer handles the blocking data transfer transparently (in a non blocking manner) so that other tasks continue to be executed.

NIO 1208 typically will provide other higher level asynchronous requests for the higher level application to use, when implementing the request in a lower level layer with the operating system as described above for reading a block of content. Such actions could be an asynchronous read of a line of data (to be determined as a chunk of data ending with a new-line character), read an HTTP request header (complete a full HTTP request header) or other options. In these cases NIO will read chunks of data, and will determine when the requested data is met, and will return the required object.

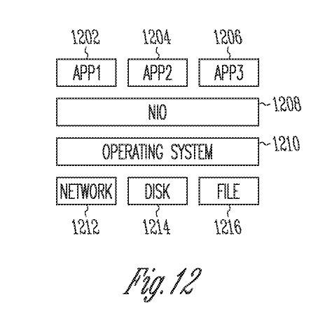

FIG. 14 is an illustrative drawing functionally representing a virtual “tunnel” 1400 of data used to deliver data read from one device to be written to another device that can be created by a higher level application using the NIO framework. Such virtual tunnel could be used, for example, when serving a cached file to the client (reading data from the file or disk, and sending it on a socket to the client) or when delivering content from a secondary server (origin or another proxy or caching server) to a client. In this example, through module 1402, a higher level application 1202, for instance, issues a request for a block of data from the NIO 1208. Note that although this example refers to a sized-based block of data, the process also could involve a “get line” from an HTTP request or a “get header” from an HTTP request, for example. Module 1302 involves a non blocking call that is made as described with reference to FIGS. 3B-3C since there may be significant latency involved with the action. Continuing with the example, when the block of data is available in memory to be used by the application as indicated by module 1404, an event will be sent to the requesting application, and the data will be then processed in memory and adjusted as indicated by module 1406 based on the settings, to be sent on the second device. Such adjustments could be (but are not limited to) uncompressing the object, in case where the receiving client does not support compression, changing encoding, or other. Once the data is modified and ready to be sent, an asynchronous call to NIO will take place indicated by module 1408 asking to write the data the second device (for instance a TCP socket connected to the requesting client). Module 1308 involves a non blocking call that is made as described with reference to FIGS. 3B-3C since there may be significant latency involved with the action. When the block of data was successfully delivered to the second device, NIO will indicate, as represented by arrow 1410, to the application that the write has completed successfully. Note that this indication this does not necessarily mean that the data was actually delivered to the requesting client, but merely that the data was delivered to the sending device, and is now either in the device's sending buffers or sent. At that point the application can issue a request to NIO for another block, or if the data was completed—to terminate the session. In this manner, a task and the NIO layer can more efficiently communicate as an application level task incrementally consumes data that becomes available incrementally from the NIO layer. This implementation will balance the read and write buffers of the devices, and will ensure that no data is brought into the server memory before it is needed. This is important to enable efficient memory usage, utilizing the read and write buffers.

### Software Components of CDN Server

As used herein a ‘custom object’ or a ‘custom process’ refers to an object or process that may be defined by a CDN content provider to run in the course of overall CDN process flow to implement decisions, logic or processes that affect the processing of end-user requests and/or responses to end-user requests. A custom object or custom process can be expressed in program code that configures a machine to implement the decisions, logic or processes. A custom object or custom process has been referred to by assignor of the instant application as a ‘cloudlet’.

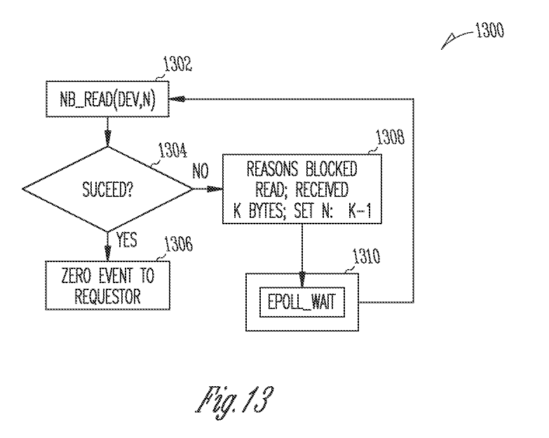

FIG. 15 is an illustrative drawing showing additional details of the architecture of software running within a proxy server in accordance with some embodiments. An operating system 1502 manages the hardware, providing filesystem, network drivers, process management, security, for example. In some embodiments, the operating system comprises a version of the Linux operating system, tuned to serve the CDN needs optimally. A disk management module 1504 manages access to the disk/storage. Some embodiments include multiple file systems and disks in each server. In some embodiments, the OS 1502 provides a filesystem to use on a disk (or partition). In other embodiments, the OS 1502 provides direct disk access, using Asynchronous IO (AIO), 1506 which permits applications to access the disk in a non-blocking manner. The disk management module 1504 prioritizes and manages the different disks in the system since different disks may have different performance characteristics. For example, some disks may be faster, and some slower, and some disks may have more available memory capacity than others. An AIO layer 1506 is a service provided by many modern operating systems such as Linux for example. Where raw disk access using AIO is used, the disk management module 1504 will manage a user-space filesystem on the device, and will manage the read and write from and to the device for optimal usage. The disk management module 1504 provides APIs and library calls for the other components in the system wanting to write or read or write to the disk. As this is a non-blocking action, it provides asynchronous routines and methods to use it, so that the entire system can remain efficient.

A cache manager 1508 manages the cache. Objects requested from and served by the proxy/CDN server may be cached locally. An actual decision whether to cache an object or not is discussed in detail above and is not part of the cache management per se. An object may be cached in memory, in a standard filesystem, in a proprietary “optimized” filesystem (as discussed above, the raw disk access for instance), as well as on faster disk or slower disk.

Typically, an object which is in memory also will be mapped/stored on a disk. Every request/object is mapped so that the cache manager can lookup on its index table (or lookup table) all cached objects and detect whether an object is cached locally on the server or not. Moreover, specific data indicative of where an object is stored, and how fresh the object is, as well as when was it last requested also are available to the cache manager 1508. An object is typically identified by its “cache-key” which is a unique key for that object that permits fast and efficient lookup for the object. In some embodiments, the cache-key comprises some hash code on a set of parameters that identifies the object such as the URL, URL parameters, hostname, or a portion of it as explained above. Since cache space is limited, the cache manager 1508 deletes/removes objects from cache from time to time in order to release space to cache new or more popular objects.

A network management module 1510 manages network related decisions and connections. In some embodiments, network related decisions include finding and defining optimal routes, setting and updating IP addresses for the server, load balancing between servers, and basic network activities such as listening for new connections/requests, handling requests, receiving and sending data on established connections, managing SSL on connections where required, managing connection pools, and pooling requests targeted to the same destination on same connections. Like with the disk management module 1504, the network management module 1510 provides its services in a non-blocking asynchronous manner, and provides APIs and library calls for the other components in the system through the NIO (network IO) layer 1512 described above. The network management module 1510 together with the network optimization module 1514 aims to achieve effective network usage.

A network optimization module 1514 together with connection pools 1516 manages the connections and the network in an optimal way, following different algorithms, which form no part of the present invention, to obtain better utilization, bandwidth, latency, or route to the relevant device (be it the end-user, another proxy, or the origin). The network optimization module 1514 may employ methods such as network measurements, roundtrip time to different networks, and adjusting network parameters such as congestion window size, sending packets more than once, or other techniques to achieve better utilization. The network management module 1510 together with the network optimization module 1514 and the connection pools 1516 aim at efficient the network usage.

A request processor module 1518 manages request processing within a non-blocking asynchronous environment as multiple non-blocking tasks, each of which can be completed separately once the required resources become available. For example, parsing a URL and a host name within a request typically are performed only when the first block of data associated with a request is retrieved from the network and is available within server memory. To handle the requests and to know all the customers' settings and rules the request processor 1518 uses the configuration file 1520 and the views 1522 (the specific views are part of the configuration file of every CDN content provider).

The configuration file 1520 specifies information such as which CDN content providers are served, identified by the hostname, for example. The configuration file 1520 also may provide settings such as the CDN content providers' origin address (to fetch the content from), headers to add/modify (for instance—adding the X-forwarded-for header as a way to notify an origin server of an original requester's IP address), as well as instructions on how to serve/cache the responses (caching or not caching, and in case it should cache, the TTLs), for example.

Views 1522 act as filters on the header information such as URL information. In some embodiments, views 1522 act to determine whether header information within a request indicates that some particular custom object code is to be called to handle the request. As explained above, in some embodiments, views 1522 specify different handling of different specific file types indicated within a request (using the requested URL file name suffix, such as “.jpg”), or some other rule on a URL (path), for example.

A memory management module 1524 performs memory management functions such as allocating memory for applications and releasing unused memory. A permissions and access control module 1526 provides security and protects against performance of unprivileged tasks and prevents users from performing certain tasks and/or to accessing certain resources.

A logging module 1528 provides a logging facility for other processes running on the server. Since the proxy server is providing a ‘service’ that is to be paid for by CDN content providers, customer requests handled by the server and data about the request are logged (i.e. recorded). Logged request information is used trace errors, or problems with serving the content or other problems. Logged request information also is used to provide billing data to determine customer charges.

A control module 1530 is in charge of monitoring system health and acts as the agent through which the CDN management (not shown) controls the server, sends configuration file updates, system/network updates, and actions (such as indicating the need to purge/flush content objects from cache). Also, the control module 1530 acts as the agent through which CDN management (not shown) distributes custom object configurations as well as custom object code to the server.

A custom object framework 1532 manages the launching custom objects and manages the interaction of custom objects with other components and resources of the proxy server as described more fully below.

### Custom object Framework

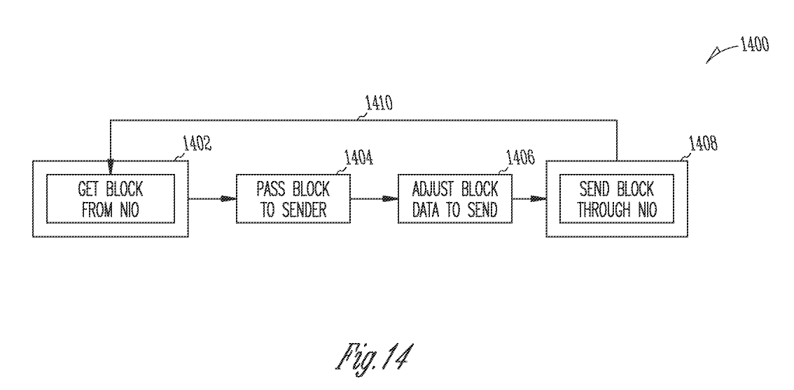

FIG. 16 is an illustrative drawing showing details of the custom object framework that is incorporated within the architecture of FIG. 15 running within a proxy server in accordance with some embodiments. The custom object framework 1532 includes a custom object repository 1602 that identifies custom objects known to the proxy server according to the configuration file 1520. Each custom object is registered with a unique identifier, its code and its settings such as an XSD (XML Schema Definition) file indicating a valid configuration for a given custom object. In some embodiments, an XSD file setting for a given custom object is used to determine whether a given custom object configuration is valid.

The custom object framework 1532 includes a custom object factory 1604. The custom object factory 1604 comprises the code that is in charge of launching a new custom object. Note that launching a new custom object does not necessarily involve starting a new process, but rather could use a common thread to run the custom object code. The custom object factory 1604 sets the required parameters and environment for the custom object. The factory maps the relevant data required for that custom object, specifically—all the data of the request and response (in case a response is already given). Since request and/or response data for which a custom object is launched typically already is stored in a portion of memory 1606 managed by the memory management module 1524, the custom object factory 1604 maps the newly launched custom object to a portion of memory 1606 containing the stored request/response. The custom object factory 1604 allocates a protected namespace to the launched custom object, and as a result, the custom object does not have access to files, DB (database) or other resources that are not in its namespace. The custom object framework 1532 blocks the custom object from accessing other portions of memory as explained below.

In some embodiments, a custom object is launched and runs in what shall be referred to as a ‘sandbox’ environment 1610. In general, in computer security terms, a ‘sandbox’ environment is one in which one or more security mechanisms are employed to separate running programs. A sandbox environment often is used to execute untested code, or untrusted programs obtained from unverified third-parties, suppliers and untrusted users. A sandbox environment may implement multiple techniques to limit custom object access to the sandbox environment. For example, a sandbox environment may mask a custom object's calls, limit memory access, and ‘clean’ after the code, by releasing memory and resources. In the case of the CDN embodiment described herein, custom objects of different CDN content providers are run in a ‘sandbox’ environment in order to isolate the custom objects from each other during execution so that they do not interfere with each other or with other processes running within the proxy server.

The sandbox environment 1610 includes a custom object asynchronous communication interface 1612 through which custom objects access and communicate with other server resources. The custom object asynchronous communication interface 1612 masks system calls and accesses to blocking resources and either manages or blocks such calls and accesses depending upon circumstances. The interface 1612 includes libraries/utilities/packaging 1614-1624 (each referred to as an ‘interface utility’) that manage access such resources, so that the custom object code access can be monitored and can be subject to predetermined policy and permissions, and follow the asynchronous framework. In some embodiments, the illustrative interface 1612 includes a network access interface utility 1614 that provides (among others) file access to stored data on a local or networked storage (e.g., an interface to the disk management, or other elements on the server). The illustrative interface 1612 includes a cache access interface utility 1618 to store or to obtain content from cache; it communicates with, or provides an interface to the cache manager. The cache access interface utility 1618 also provides an interface to the NIO layer and connection manager when requesting some data from another server. The interface 1612 includes a shared/distributed DB access interface utility 1616 to access a no-sql DB, or to some other instance of a distributed DB. An example of a typical use of the example interface utility 1616 is access to a distributed read-only database that may contain specific customer data to be used by a custom object, or some global service that the CDN can provide. In some cases these services or specific DB instances may be packaged as a separate utility. The interface 1612 includes a geo map DB interface utility 1624 that maps IP ranges to specific geographic location 1624. This example utility 1624 can provide this capability to custom object code, so that the custom object code will not need to implement this search separately for every custom object. The interface 1612 also includes a user-agent rules DB interface 1622 that lists rules on the user-agent string, and provides data on the user-agent capabilities, such as what type of device it is, version, resolution or other data. The interface 1612 also can include an IP address blocking utility (not shown) that provides access to a database of IP addresses to be blocked, as they are known to be used by malicious bots, spy network, or spammers. Persons skilled in the art will appreciate that the illustrative interface 1612 also can provide other interface utilities.

### Custom Object

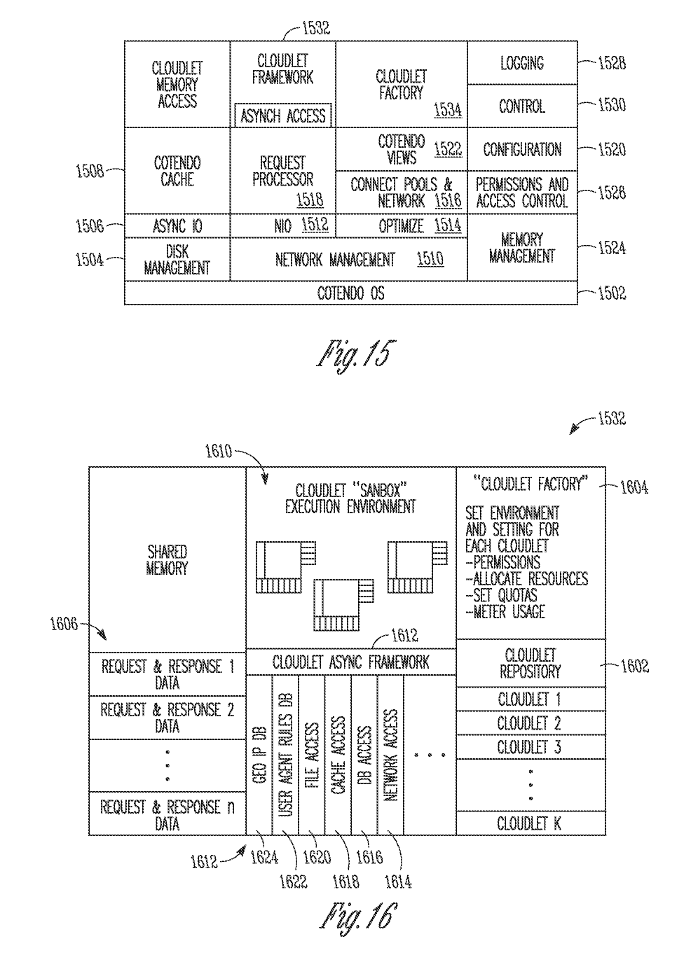

FIG. 17 is an illustrative drawing showing details of a custom object that runs within a sandbox environment within the custom object framework of FIG. 16 in accordance with some embodiments. The custom object 1700 includes a meter resource usage component 1702 that meters and logs the resources used by the specific custom object instance. This component 1702 will meter CPU usage (for instance by logging when it starts running and when it is done), memory usage (for instance, by masking every memory allocation request done by the custom object), network usage, storage usage (both also as provided by the relevant services/utilities), or DB resources usage. The custom object 1700 includes a manage quotas component 1704 and a manage permissions component 1706 and a manage resources component 1708 to allocate and assign resources required by the custom object. Note that the sandbox framework 1532 can mask all custom object requests so as to manage custom object usage of resources.

The custom object utilizes the custom object asynchronous communication interface 1612 from the framework 1532 to obtain access to and to communicate with other server resources.

The custom object 1700 is mapped to a particular portion of memory 1710 shown in FIG. 17 within the shared memory 1606 shown in FIG. 16 that is allocated by the custom object factory 1604 to the portion of memory 1710 that can be accessed by the particular custom object. The memory portion 1710 that contains an actual request associated with the launching of the custom object and additional data on the request (e.g., from the network, configuration, cache, etc.), and a response if there is one. The memory portion 1710 represents the region of the actual memory on the server where the request was handled at least until that point.

### Request Flow

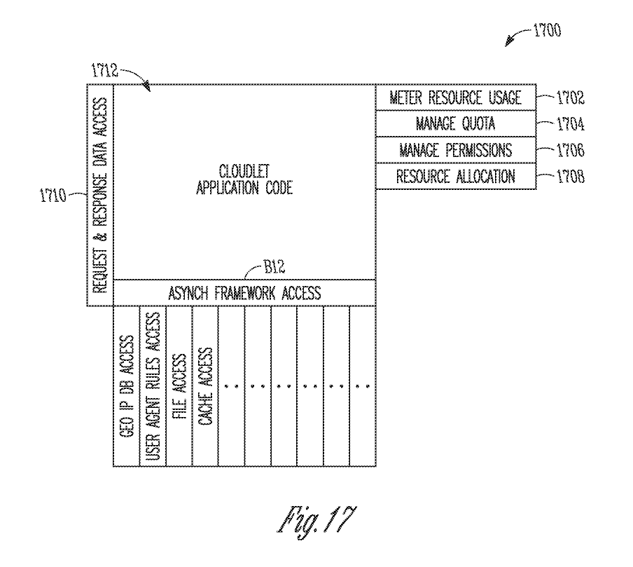

FIG. 18 is an illustrative flow diagram that illustrates the flow of a request, as it arrives from an end-user's user-agent in accordance with some embodiments. It will be appreciated that a custom object implements code that has built-in logic to implement request (or response) processing that is customized according to particular CDN provider requirements. The custom object can identify external parameters it may get for specific configuration. Initially, the request is handled by the request processor 1518. Actually the request is first handled by the OS 1502 and the network manager 1510, and the request processor 1518 will obtain the request via the NIO layer 1512. However, as NIO 1518 and the network manager 1512 as well as the disk/storage manager 1504 are involved in every access to network or disk, they are not shown in this diagram in order to simplify the explanation.

The request processor 1512 analyzes the request and will match it against the configuration file 1520, including customer's definitions (specifically—the hostnames that determines who is the customer the request is served for), and the specific views defined for that specific hostname with all the specific configurations for these views.

The CDN server components 1804 represent the overall request processing flow explained above with reference to FIGS. 3A-14, and so it encapsulates those components of the flow, such as the cache management, and other mechanisms to serve the request. Thus, it will be appreciated that processing of requests and responses using a custom object is integrated into the overall request/response processing flow, and coexists with the overall process. A single request may be processed using both the overall flow described with reference to FIGS. 3A-14 and through custom object processing.

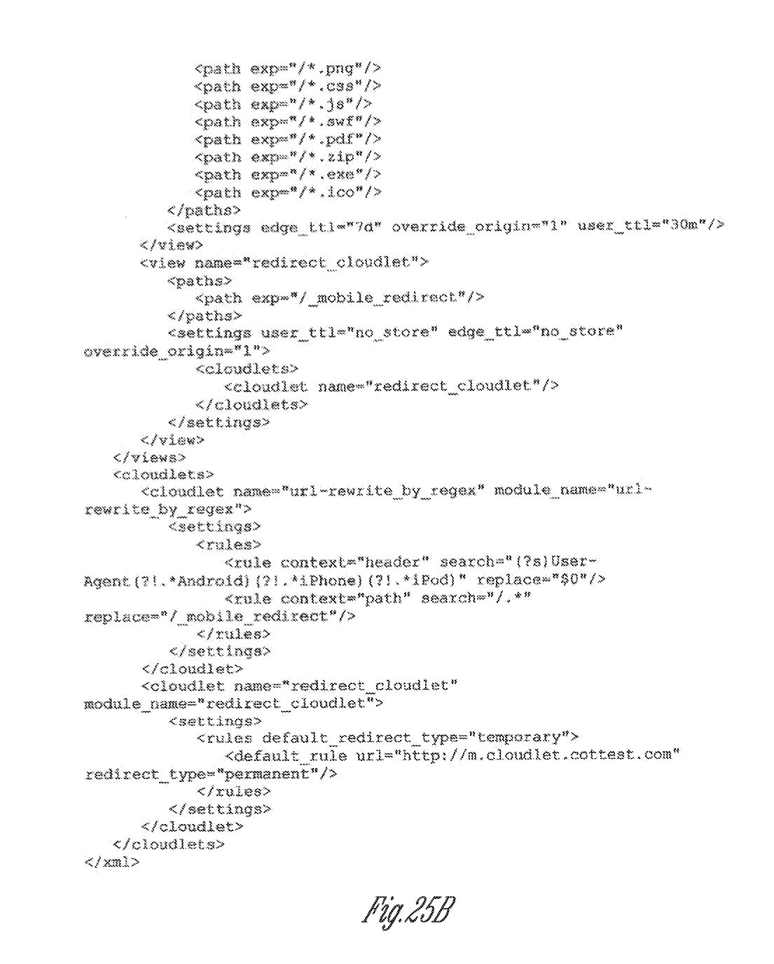

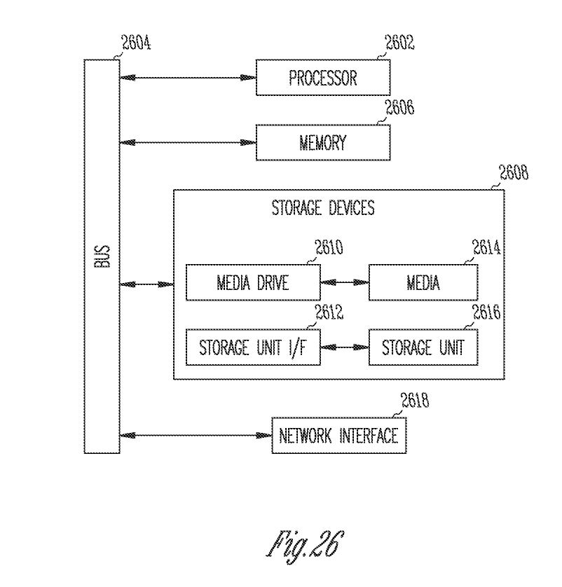

As the request processor 1518 analyzes the request according to the configuration 1520, it may conclude that this request falls within a specific view, say “View V” (or as illustrated in the example Custom object XML configuration files of FIGS. 25, 26A-26B—showing the view, and the configuration of it, as well as the configuration of the custom object instance for the view). In this view, let us assume that it is indicated that “custom object X” will handle this request (potentially there could be a chain of custom objects instructed to handle the request one after the other, but as a request is processed serially, first a single custom object is called, and in this case we assumed it is “custom object X”).

In order to launch the specific code of custom object X to handle the request/perform its logic, the request processor 1518 will call the custom object factory 1604, providing the configuration for the custom object, as well as the context of the request: i.e. relevant resources already assigned the request/response, customer ID, memory, and the unique name of the custom object to be launched.

The factory 1604 will identify the custom object code in the custom object repository 1602 (according to the unique name), and will validate the custom object configuration according to the XSD provided with the custom object. Then it will set up the environment: define quotas, permissions, map the relevant memory and resources, and launch the custom object X having an architecture like that illustrated in FIG. 17 to run within the custom object sandbox environment [[B10]] 1610 illustrated in FIG. 16. The custom object X provides logging, metering, and verifies permissions and quotas (according to the identification of the custom object instance as the factory 1604 set it). The factory 1604 also will associate the custom object X instance with its configuration data. Once the custom object starts running, it can perform processes specified by its code 1712, which may involve configuring a machine to perform calculations, tests and manipulations on the content, the request and the response themselves, as well as data structures associated to them (such as time, cache instructions, origin settings, and so on), for example.

The custom object X runs in the ‘sandbox’ environment 1610 so that different custom objects do not interfere with each other. Custom object access to “protected” or “limited” resources through interface utilities as described above such as using a Geo-IP interface utility 1624 to obtain resolution as to the exact geo location where the request arrived from; using a cache interface utility 1620 to get or place an object from/to the cache; or using a DB interface utility 1622 to obtain data from some database, or another interface utility (not shown) from the services described above.

Once the custom object X completes its task, the custom object framework 1532 releases specific resources that were set for the custom object X, and control returns to the request processor 1518. The request processor 1518 will then go back to the queue of waiting tasks described above with reference to FIGS. 3B-3C, for example, and will handle the next task as described with reference to FIG. 3B.

Custom object code can configure a machine to impact on the process flow of a given request, by modifying the request structure, changing the request, configuring/modifying or setting up the response, and in some cases generating new requests—either asynchronous (their result will not impact directly on the response of this specific request), or synchronous—i.e. the result of the new request will impact on the existing one (and is part of the flow). Note that here when saying synchronous and asynchronous it is said in the context of the request flow, and not of the server, which itself runs asynchronously, non blocking. But the request which is broken to separate tasks, can be either completed while initiating a new request that will be handled in parallel, by not impacting on the initial request, and not preventing it from completion—thus asynchronous.

For example, a custom object can cause a new request to be “injected” into the system by adding it to the queue, or by launching the “HTTP client” described above with reference to FIGS. 3A-14. Note that a new request may be internal (as in a rewrite request case, where the new request should be handled by the local server), or external—such as when forwarding a request to the origin, but also could be a new generated request.

According to the request flow—the request may be then forwarded to the origin (or a second proxy server) 1518, returned to the user, terminated, or further processed—either by another custom object, or by the flow described above with reference to FIGS. 3A-14 (for instance—checking for the object in cache)

When getting the response back from the origin, again the request processor 1518 is handling the flow of the request/response, and according to the configuration and the relevant view, may decide to launch a custom object to handle the request, or to direct it to the standard CDN handling process, or some combination of them (first one and then the other)—again, in that direction as well, the request processor 1518 will manage the flow of the request until it determines to send the response back to the end-user.

### CDN Content Provider Management Update of Custom objects

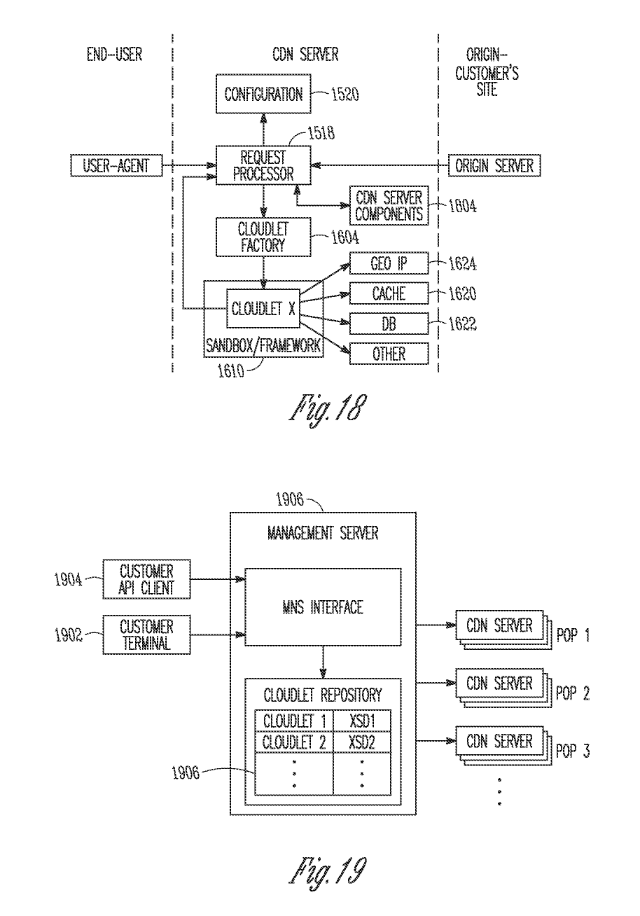

FIG. 19 is an illustrative flow diagram to show deployment of new custom object code in accordance with some embodiments. The process of FIG. 19 may be used by a CDN content provider to upload a new custom object to the CDN. The CDN content provider may use either a web interface (portal) through a web portal terminal 1902 to access the CDN management application, or can use a program/software to access the management interface via an API 1904. A management server 1906 through the interface will receive the custom object code, a unique name, and the XSD determining the format of the XML configuration that the custom object code supports.

The unique name can be either provided by the customer—and then verified to be unique by the management server (returning an error if not unique), or can be provided by the management server and returned to the customer for further use of the customer (as the customer will need the name to indicate he wants the specific custom object to perform some task).

At that point the management server 1906 will store the custom object together with its XSD in the custom object repository 1908, and will distribute the custom object with its XSD for storage within respective custom object repositories (that are analogous to custom object repository 1602) of all the relevant CDN servers, (e.g. custom object repositoruies of CDN servers within POP1, POP2, POP3) that communicate with the management/control agent on each such server.

It will be appreciated that FIG. 19 illustrates deployment of a new custom object code (not configuration information). Once a custom object is deployed, it may be used by CDN content provider/s through their configurations. A configuration update is done in a similar way, updating through the API 1904 or the web portal 1902, and is distributed to the relevant CDN servers. The configuration is validated by the management server 1906, as well as by each and every server when it gets a new configuration. The validation is done by the standard validator of the CDN configuration, and every custom object configuration section is validated with its provided XSD)

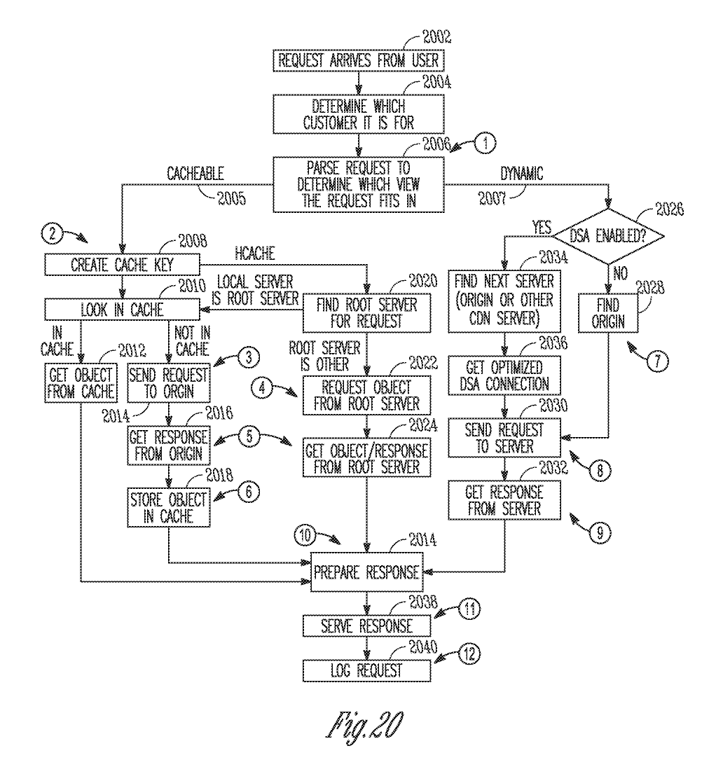

FIG. 20 is an illustrative flow diagram of overall CDN flow according to FIGS. 4-9 in accordance with some embodiments. The process of FIG. 20 represents a computer program process that configures a machine to perform the illustrated operations. Moreover, it will be appreciated that each module 2002-2038 of FIG. 20 represents configuration of a machine to perform the acts described with reference to such module. FIG. 20 and the following description of the FIG. 20 flow provide context for an explanation of how custom object processes can be are embedded within the overall CDN request flow of FIGS. 4-9 in accordance with some embodiments. In other words, FIG. 20 is included to provide an overall picture of the overall CDN flow. Note that FIG. 20 provides a simplified picture of the overall flow that is described in detail with reference to FIGS. 4-9 in order to avoid getting lost in the details and to simplify the explanation. Specifically, FIG. 20 omits certain details of some of the sub-processes described with reference to FIGS. 4-9. Also, the error-handling case of FIG. 8 is not illustrated in FIG. 20 in order to simplify the picture. A person skilled in the art may refer to the detailed explanation of the overall process provided in FIGS. 4-9 in order to understand the details of the overall CDN process described with reference to FIG. 20.

Module 2002 receives a request, such as an HTTP request, that arrives from an end-user. Module 2004 parses the request to identify the CDN content provider (i.e. the ‘customer’) to which the request is directed. Module 2006 parses the request to determine which view best matches the request, the Hcache view, regular cache view or DSA view in the example of FIG. 20.

Assuming that module 2006 selects branch 2005, module 2008 creates a cache key. If the cache key indicates that the requested content is stored in regular local cache, then module 2010 looks in regular cache of the proxy server that received the request. If module 2010 determines that the requested content is available in the local regular cache, then module 2012 gets the object from regular cache and module 2014 prepares a response to send the requested content to the requesting end-user. However, if module 2010 determines that the requested content is not available in local regular cache then module 2013 sends a request for the desired content to the origin server. Subsequently, module 2016 obtains the requested content from the origin server. Module 2018 stores the content retrieved from the origin in local cache, and module 2014 then prepares a response to send the requested content to the requesting end-user.

If the cache key created by module 2008 determines that the requested content is stored in hierarchical cache, then module 2020 determines a root server for the request. Module 2022 requests the content form the root server. Module 2024 gets the requested content from the root server, and module 2014 then prepares a response to send the requested content to the requesting end-user.

Assuming now that module 2006 selects branch 2007, module 2026 determines whether DSA is enabled. If module 2026 determines that DSA is not enabled, then module 2028 identifies the origin server designated to provide the content for the request. Module 2030 sends a request for the desired content to the origin server. Module 2032 gets a response from the origin server that contains the requested content, and module 2014 then prepares a response to send the requested content to the requesting end-user.

If, however, module 2026 determines that DSA is enabled, then module 2034 locates a server (origin or other CDN server) that serves the content using DSA. Module 2036 obtains an optimized DSA connection with the origin or server identified by module 2034. Control then flows to module 2030 and proceeds as described above.

Assuming that the cache branch 2005 or the dynamic branch 2007 has resulted in control flow to module 2014, then module 2038 serves the response to the end-user. Module 2040 logs data pertinent to actions undertaken to respond to the request.

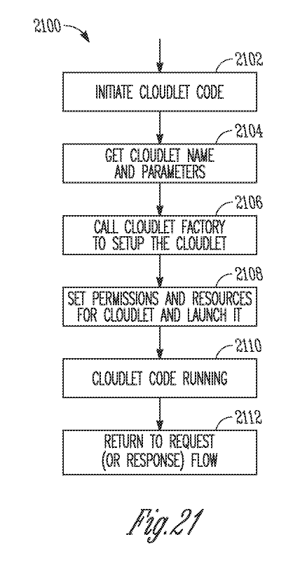

FIG. 21 is an illustrative flow diagram of a custom object process flow 2100 in accordance with some embodiments. The process of FIG. 21 represents computer program process that configures a machine to perform the illustrated operations. Moreover, it will be appreciated that each module 2102-2112 of FIG. 21 represents configuration of a machine to perform the acts described with reference to such module. The process 2100 is initiated by a call from a module within the overall process flow illustrated in FIG. 20 to the custom object framework. It will be appreciated that the process 2100 runs within the custom object framework 1532. Module 2102 runs within the custom object framework to initiate custom object code within the custom object repository 1602 in response to a call. Module 1604 gets the custom object name and parameters provided within the configuration file and uses them to identify which custom object is to be launched. Module 2106 calls the custom object factory 1604 to setup the custom object to be launched. Module 2108 sets permissions and resources for the custom object and launches the custom object. Module 2110 represents the custom object running within the sandbox environment 1610. Module 2112 returns control to the request (or response) flow.

Note that module 2110 is marked as potentially blocking There are cases where the custom object runs and is not blocking. For instance a custom object may operate to check the IP address and to verify that it is within the provided ranges of permitted IP addresses as provided in the configuration file. In that case, all the required data is in local server memory, and the custom object can check and verify without making any potentially blocking call, and the flow 2100 will continue uninterrupted to the standard CDN flow. However, if module custom object is required to perform some operation such as terminating a connection, or sending a “403” response to the user, indicating that this request is unauthorized, for example, then the custom object running in module 2110 (terminating or responding) are potentially blocking

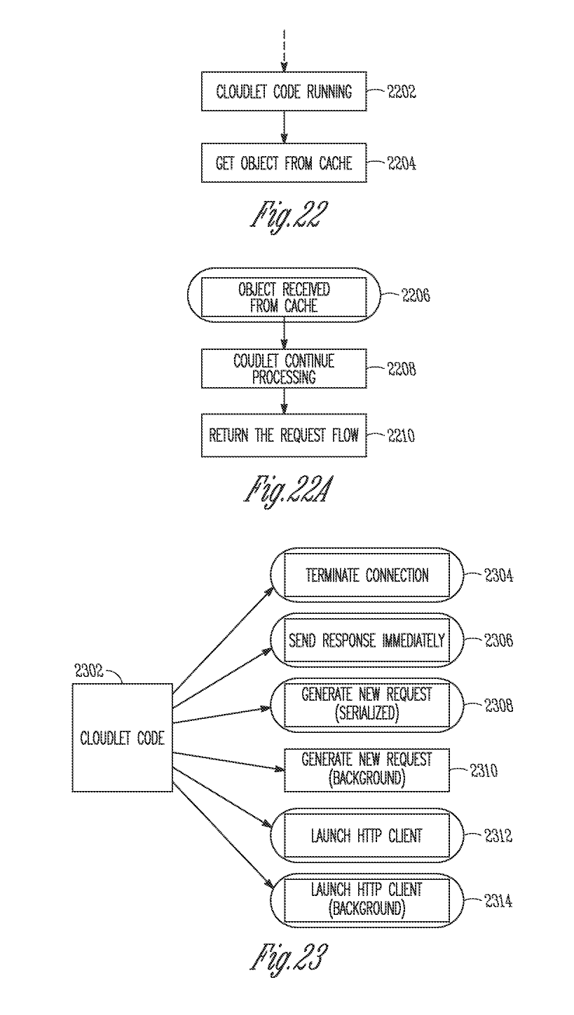

FIG. 22A-22B are illustrative drawings showing an example of an operation by custom object running within the flow of FIG. 21 that is blocking Module 2202 represents a custom object running as represented by module 2110 of FIG. 21. Module 2204 shows that the example custom object flow involves getting an object from cache, which is a blocking operation. Module 2206 represents the custom object waking up from the blocking operation upon receiving the requested content from cache. Module 2208 represents the custom object continuing processing after receiving the requested content. Module 2210 represents the custom object returning control to the overall CDN processing flow after completion of custom object processing.

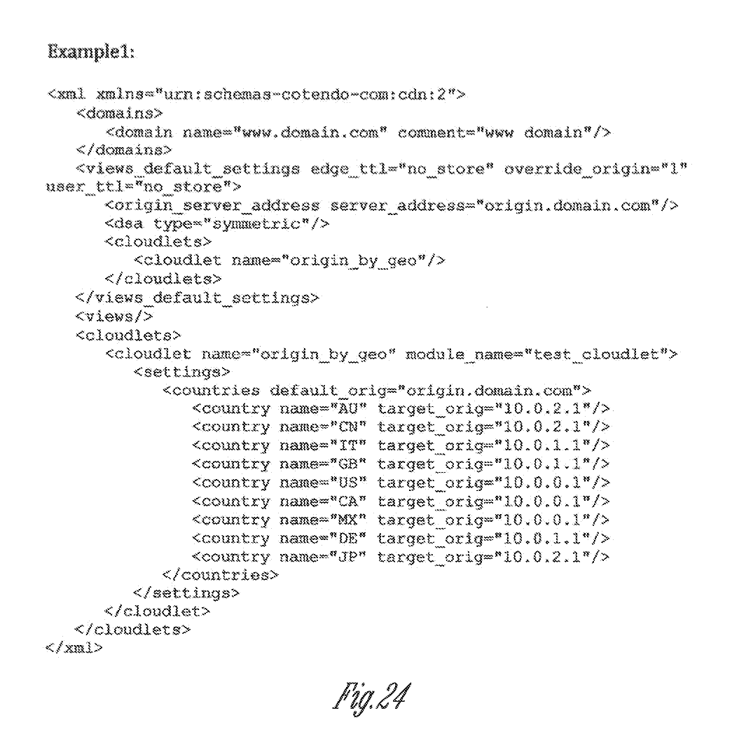

FIG. 23 is an illustrative flow diagram that provides some examples to potentially blocking services that the custom object may request in accordance with some embodiments. FIG. 23 also distinguishes between two types of tasks that apply to launching HTTP client and a new request which identifies whether the request is serialized or not (in other places in this document, this may be referred as synchronous, but to avoid confusion with the asynchronous framework we use the term ‘serialized’ here.). In a serialized request, the response/result of the request is needed in order to complete the task. For example, when handling a request for an object, initiating an HTTP client to get the object from the origin is ‘serialized’, in that only when the response from the origin is available, can the original request be answered with a response containing the object that was just received.

In contrast, a background HTTP client request may be used for other purposes as described in the paragraphs below, but the actual result of the client request will not impact the response to the original request, and the data received is not needed in order to complete the request. In the case of a background request, after adding the request to the queue, the custom object can continue its tasks since it need not await the result of the request. An example of a background HTTP request is an asynchronous request to the origin for the purpose of informing the origin of the request (e.g., for logging or monitoring purposes). Such a background HTTP request should not affect the response to the end-user, and the custom object can serve the response to the user even before sending the request to the origin. In FIG. 23 background type of requests are marked as non-blocking, as actually they are not processed immediately, but rather are merely added to the task queue 322.

### Example Custom object Actions

Referring to FIG. 20, the following paragraphs provide illustrative examples of actions that may be performed using custom object processes at various modules of the overall CDN flow.

The following are examples of custom object processes that can be called from module 2006.
1) as the request is received from the user:
   i. apply access control list (ACL) rules, and advanced access control rules. The custom object can inspect the request and block access based on characteristics of the request and the specific view. For instance, a customer may want to enable access to the site only to users coming from iPhone device, from a specific IP range, or from specific countries, or regions, and block all other requests, returning HTTP 403 response, redirecting to some page, or simply resetting the connections mentioned above—the customer is identified by the host name in the HTTP request header. This customer may have configured a list of IP-ranges to whitelist/blacklist and custom object can apply the rule.
   b. Based on the specified request (or “view”)—a custom object can generate a response page and serve it directly, bypassing the entire flow. Again—in that case custom object may extend the notion of view by inspecting parameters of the request that the common CDN framework does not support—in any given time the CDN will know to identify based on some predefined arguments/parameters. For instance, assume that the CDN does not support “cookies” as part of the “View” filtration. It is important to understand that this is just an example, as there is not a real limitation on the ability to add it to the View, but in any given time, there will be parameters that are not part of it.
   c. Based on the specified request a custom object can rewrite the request as another request—for example, rewriting a request based on the geo-location to incorporate the location. So that a request of the form www.x.com/path/file coming from Germany will be rewritten as www.x.com/de/path/file, or a request of the form www.x.com/item/item-id/item-name will be rewritten as www.x.com/item.php?id=item-id). Once the request is rewritten—it could now either be treated as a new request in the system (the custom object code will generate a new request, nested in the current, that will be treated as a new request and will follow the standard CDN flow), or may immediately bypass the logic/flow and send the new request directly to an origin (including an alternative origin that may be determined by the custom object), or to another CDN server (like in the case of DSA).—decisions on geo targeting, smart caching, and so on that are typically done today on the origin, can now be done on the edge. Another example—a large catalogue of items, may be presented to the world in a URL which reflects the search/navigation to the item. So that x.com/tables/round/12345/ikea-small-round-table-23 and x.com/ikea/brown/small/12345/ikea-small-round-table-23 are actually the same item, and can be cached as the same object. By that reducing the load from the origin, improving cache efficiency and improving site performance—when moving the logic understanding the URL to the edge.)
   d. Similar to the rewrite custom object can redirect—where instead of serving the new request on top of the existing one, custom object will immediately send a HTTP response with code 301 or 302 (or other) and a new URL to redirect—indicating the browser to get the content from the new URL. By doing that, this is similar to generating the page and serving it directly from the edge.
   e. In this initial stage a custom object code can implement different authentication mechanism to verify permissions or credentials of the end-user issuing the request. Assuming the customer wants us to authenticate the users with some combination of user/password, and specific IP ranges, or enabling access only from specific regions, or to verify a token that enables access within a range of time. Each customer may use different authentication methods.

The following are examples of custom object processes that can be called from module 2008.
2) Custom object code may replace the default method used by the CDN to define the cache-key. For instance—the custom object code can specify that for a specific request the cache-key will be determined by additional parameters, less parameters, or different parameters.
   a. For instance—in a case where the customer wants to serve different content to different mobile users when requesting a specific page (all requesting the same URL), the origin can determine the type of the mobile device according to the user-agent for instance.—User-agent is an HTTP header, part of the HTTP standard, where the user agent (mobile device, browser, spider or other) can identify itself. In that case, the customer will want the requests to be served and cached according to the user-agent. To do that—one can add the user-agent to the cache-key, or more accurately, some condition on the user-agent, as devices of the same type may have slightly different user-agents.
   b. Another example will be to add a specific cookie value to the cache-key. Basically the cookie is set by the customer, or could also be set by a custom object code based on customer configuration).
   c. Another example could be a case where the custom object processes the URL into some new URL, or picks some specific parts of the URL and will use only them when determining the cache-key. For instance—for a url of the format HOST/DIR1/DIR2/DIR3/NAME, a custom object can determine that the only values to be used to determine the uniqueness of a request are HOST,DIR1,DIR3, as due to the way the web application is written the same object/page could be referred in different ways, where adding some data in the URL structure (DIR2 and NAME), though the additional data is not relevant in order to serve the actual request—in this example custom object will “understand” the URL structure, and can thus handle it and cache it more efficiently, avoiding duplications and so on)

The following are examples of custom object processes that can be called from module 2014.
3) When (or before) sending a request to the origin, a custom object can manipulate the request and change some of the data in the request. (also with 2022, 2028, 2030). The configuration file will identify the custom objects to be used for a specific view. However—as a view is determined by a request, when configuring a custom object to handle a request—we also provide the method of this custom object, specifying in what part of the flow it is supposed to be called. For instance—“on request from user”, “on response to user”, “on response from origin”.
   a. Adding HTTP headers to indicate something or provide some additional data to the server
   b. Changing the origin server address
   c. Changing the host string in the HTTP request (note that this could be done also as the request is received, but will get a different impact—as the host string may be part of the cache-key and view)

The following are examples of custom object processes that can be called from module 2022.
4) Similar to 3.

The following are examples of custom object processes that can be called from modules 2024 and 2016 and 2032.
5) (also 9) As the response is received a custom object code can be triggered to handle the response before it is further processed by the CDN server. This could be in order to change or manipulate the response, or for some logic differences or flow changes. Some examples:
   a. add some information for logging purposes
   b. modify the content or data as it is received (for instance—if the content is cacheable, so that the modified content/object will be cached and not the original).
      i. two examples: 1) geo based—for instance replacing strings with the relevant data of the region where the proxy server is located
      ii. 2) personal page: assume a page contains specific end-users's data. Think of a frequent flyer web-site. Once you log in—most customer see ALMOST the same page with some small differences from one user to another: user name, # of miles gained so far, status, and so on. However, the page design, promotions, and most of the page is identical. The pre-storing part, when requesting the response from the origin can “pre-process” or “sterilize” the page not to contain any personal data (instead replacing it with “place-holders”). When the response is served, the personalized data can be inserted into the page, as this is in the context of a specific request from a known user. The personalized data can be retrieved from the request (the username for instance may be kept in the cookie), or from a specific request that gets from the origin ONLY the real personalized/dynamic content.
   c. Trigger a new request as a result of the response. For instance—assume a multi step process, where the initial request is sent to one server, and based on the response from the server, the CDN (through the custom object code) sends a new request to a second server, using data from the response. The response from the second server will be then returned to the end-user.
      i. in the example above—a request to page where we have a “clean/sterilized” cached version of it, we will trigger an additional request to the origin to get the personalized data of the specific request.
      ii. Assume a credit card online transaction: it can be implemented by parsing the request with the CC data and sending a specific request with the relevant data to the credit card company to get approval (done as a custom object code. The credit card company will provide a token back (approving or disapproving) another custom object code will analyze the response, grab the token and the result (approved or not) and will create an updated request with the relevant data to the merchant/retailer. This way the retailer doesn't get the credit card data, but is getting the relevant data—that the transaction is approved (or not) and can use the token to communicate back to the credit card company to finalize the transaction.
      iii. Other cases could be pre-fetching objects based on the response from the origin,
      iv. Last example—in case the response from the origin is bad—for instance, the origin is not responding, or responds with an error code, the custom object code inspecting the response can determine to try and send the request to an alternative (backup) origin server, so that the end-user will get a valid response. This may ensure business continuity and helps mitigating errors or failures in an origin server.

The following are examples of custom object processes that can be called from module 2018.
6) As the response is processed, the custom object code may modify settings on the way it should be cached, defining TTL, cache-key for storing the object, or other parameters

The following are examples of custom object processes that can be called from module 2028.
7) Covered in the description of 3 (above). Custom object code may add logic and rules on which origin to get the content from. For instance—fetching content that should be served to mobile devices from an alternative origin that is customized to serve mobile content, or getting the content from a server in Germany when the custom object code identifies. The IP source, as all other parameters relevant to a request are stored in the data structure that is associated with the request/response during the entire flow of it being served. Remember that we are typically in the same server that received the request, and even if not—these attributes are added to the session as long as it is handled) that the request is coming from Germany, or from a user-agent that the default language it supports is German.

The following are examples of custom object processes that can be called from modules 2030.
8) Similar to 3.

The following are examples of custom object processes that can be called from modules 2032.
9) Similar to 5.

The following are examples of custom object processes that can be called from modules 2013 and 2038.
10) And 11): A response maybe modified before it is sent to the end-user. For instance, when the method of delivery may be related to the specific characteristics of the end-user, or user-agent.
   a. In case the user-agent supports additional capabilities (or does not support it)—the custom object code can set the response appropriately. One example is the user-agent support of compression. Even though the user-agent may indicate in the HTTP header what formats and technologies it supports (compression for instance), there are cases where additional parameters or knowledge may indicate otherwise. For instance—a device or browser that actually supports compression, but the standard headers will indicate that it doesn't support it. a custom object code may perform the additional test (according to the provided knowledge)—Note that there are some cases where a device is known to support compression, but due to some proxy, firewall, anti-virus, or other reason the accept-encoding header will not be configured appropriately. According to the user-agent header for instance you may identify that the device actually does support compression. Another case—is by custom object testing compression support by sending a small compressed javascript, that if uncompressed properly will set a cookie to a certain value. When now serving the content, the cookie value can be inspected and it will indicate that compression is supported, you can serve compressed even though the header indicated otherwise) and decide to serve the content compressed.
   b. Add or modify headers to provide additional data to the user-agent. For instance—providing additional debug information, or information regarding the flow of the request, or cache status.
   c. Manipulate the content of the response. For instance—in an HTML page, inspect the body (the HTML code) and add, or replace specific strings with some new ones. For instance—modifying URLs in the HTML code to URLs optimized for the end-user based on his device or location. Or in another case—in order to greet the end-user on his entry page, retract from the cookie in the request the user name, and place it in the appropriate place in the cached HTML of the required page—by that enabling the page to be cached (as most of it is static) and adding the “dynamic” parts in the page before serving it, where the dynamic data is calculated from the cookie in the request, from the geo location of the user, or due to another custom object code sending a specific request for the dynamic data only to the origin, or to some database which is provided by the custom object framework.—Note that going back to the example above with “sterilizing” the content—here is the opposite case, where before serving the content to the actual user, you want to inject into the response the specific data for this user. Typically this is what the application/business logic will do on the origin. another case could be as mentioned above—modifying links to optimize for the device—if not done on the edge, this will be done on the origin)

The following are examples of custom object processes that can be called from modules 2038.
11) See 10.

The following are examples of custom object processes that can be called from modules 2040.
12) custom object framework provides additional/enhanced logging, so that one can track additional data on top of what is logged by default in the CDN. This could be for billing, for tracking, or for other uses of the CDN or of the customer. The custom object code has access to all the relevant data of the handled request (request line, request headers, cookies, request flow, decisions, results of specific custom object code, and so on) and log it, so it can then be delivered to the customer, and aggregated or processed by the CDN.

### Example Configuration Files

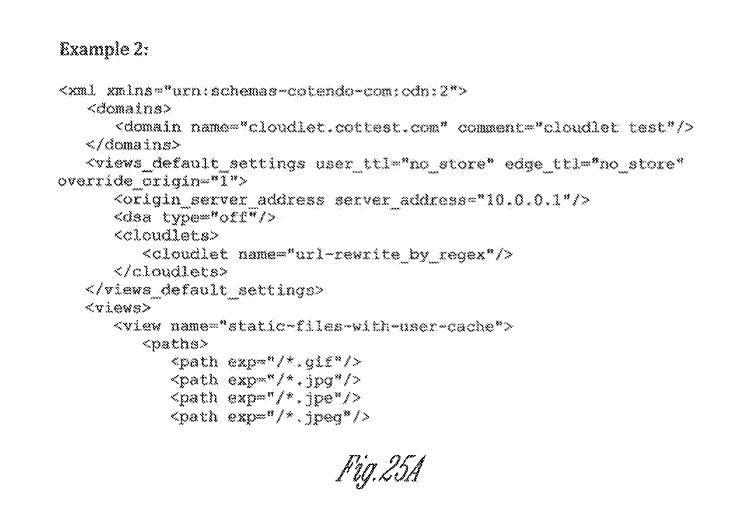

FIGS. 24 and 25A-25B show illustrative example configuration files in accordance with some embodiments.

FIG. 24 shows an Example 1. This shows an XML configuration of an origin.

One can see that the domain name is specified as www.domain.com.

The default view is configured (in this specific configuration there is only the default view, so now additional view is set). For the default view the origin is configured to be “origin.domain.com”, and DSA is enabled, with the default instruction not to cache any object—not on the edge and not on the user-agent (indicated by the instructions uset_ttl=“no_store”, edge_ttl=“no_store”.

It is also instructed that the custom object “origin_by_geo” should be handling requests in this view (in this example—this is all requests).

This custom object is coded to look for the geo from which the request is arriving, and based on configured country rules to direct the request to the specified origin.

The custom object parameters provided are specifying that the default origin will be origin.domain.com, however for the specific countries indicated the custom object code will direct the request to one of 3 alternative origins (based on where the user comes from). In this example, 10.0.0.1 is assigned for countries in North America (US, Canada, Mexico), 10.0.1.1 is assigned for some European countries (UK, Germany, Italy), and 10.0.2.1 for some Asian/Pacific countries (Australia, China, Japan).

The configuration schema of each custom object is provided with the custom object code when deployed. Each custom object will provide an XSD. This way the management software can validate the configuration provided by the customer, and can provide the custom object configuration to the custom object when it is invoked.

Each custom object can define its own configuration and schema.

FIGS. 25A-25B show an Example 2. This example illustrates using two custom objects in order to redirect end-users from mobile devices to the mobile site. In this case—the domain is custom object.cottest.com and the mobile site is m.custom object.cottest.com.

The first custom object is applied to the default view. This is a generic custom object that rewrites a request based on a provided regular expression.

This custom object is called “url-rewrite_by_regex” and the configuration can be seen in the custom object configuration section.

The specific rewrite rule which is specified will look in the HTTP header for a line starting with “User-agent” and will look for expressions indicating that the user-agent is a mobile device, in this case—will look for the strings “iPod”, “iPhone”, and “Android”. If such a match is found, the URL will be rewritten to the URL “/_mobile_redirect”.

Once rewritten, the new request is handled as a new request arriving to the system, and thus will look for the best matching view. For that purpose exactly a view is added named “redirect_custom object”. This view is defined by a path expression, specifying that only the URL “/_mobile_redirect” is included in it. When such a request to this URL is received, the second custom object, name “redirect_custom object” will be activated. This custom object redirects a request to a new URL, by sending an HTTP response with status 301 (permanent redirect) or 302 (temporary redirect). Here also rules may be applied, but in this case there is only a default rule, specifying that the request should result with sending a permanent redirect to the URL “http://m.custom object.cottest.com”.

### Alternative Architecture

Another mechanism to ensure a well-determined performance of the regular/standard CDN activity and of “certified” or “trusted” custom objects, but enabling the flexibility for a customer to “throw” in a new un-tested custom object code is by the following architecture:

We can separate in every POP the proxies to front-end proxies and back-end proxies. Further, we can separate them to “clusters”

The front-end proxy will not run customer custom objects (only Cotendo certified ones).

That means that every custom object will be tagged with a specific “target cluster”. This way a trusted custom object will run at the front, and non-trusted custom objects will be served by a farm of back-end proxies.

The front-end proxies will pass the traffic to the back-end as if they are the origins. In other words—the configuration/view determining if a custom object code should handle the request will be distributed to all proxies, so that the front proxies, when determining that a request should be handled by a custom object of a class that is served by a back-end proxy, will forward the request to the back-end proxy (just like it directs the request in HCACHE or DSA).

This way, non-custom object traffic and trusted custom object traffic will not be affected by non-trusted custom objects that are not efficient.

This will not provide a method, how to deal with the back-end farm of isolating custom objects from one customer from others.

There is no 100% solution to this. Like google, amazon and any virtualization company, there is no guarantee of performance. It's a matter of over-provisioning and monitoring and prioritization.

Note that there are two things: 1) securing the environment, preventing unauthorized access or similar—this will be enforced in all implementations, both in front-end and back-end; 2) securing performance of the system—this is what we cannot promise in a multi-tenancy server, where we host customer code which is not “certified”—in this case we can provide tools like prioritization, quota limitations, and perhaps even some minimal commitment—but as the resources are limited, one customer may impact the available resources of another customer (unlike the certified environment where we control the code and can ensure the performance and service we provide).

Isolation of non-trusted custom objects:

A custom object will have a virtual file system where every access to the filesystem will go to another farm of distributed file system. It will be limited to its own namespace so there is no security risk (custom object namespaces is explained below)

A custom object will be limited to X amount of memory. Note that this is a very complicated task in an app-engine kind of virtualization. The reason is because all the custom objects are sharing the same JVM so it's hard to know how much memory is used by a specific custom object. Note: in the Akamai J2EE patent—every customer J2EE code runs in its own separate JVM, which is very not efficient, and different from our approach]

The general idea on how to measure memory usage is not to limit the amount of memory but instead to limit the amount of memory allocations for a specific transaction. That means that a loop that allocates 1M objects of small size will be considered as if it needs a memory of 1M multiply by the sizes of the objects even if the objects are deallocated during the loop. (There is a garbage collector that removes the objects without notifying the engine). As we control the allocation of new objects—we can enforce the limitations.

Another approach is to mark every allocated object with the thread that allocated it and since a thread at a given time is dedicated to a specific custom object, one can know which custom object needed it and then mark the object with the custom object.

This way one can later detect the original zone during the garbage-collection.

Again, the challenge is how to track memory for custom objects sharing the same JVM, as one can also implement the custom object environment using another framework (or even provide a framework—like we initially did)—the memory allocation, deallocation, garbage collection and everything else is controlled, as in such a case we write and provide the framework.

Tracking CPU of non-trusted custom objects:

A custom object always has a start and end of a specific request. During that time, the custom object takes a thread for its execution (so the CPU is used in between).

There are two problems to consider:
1. detecting an infinite loop (or a too long transaction)
2. detecting a small transaction that runs many times (so overall—the customer is consuming a lot of resources from the system)

Problem 2 is not really a problem, as the customer is paying for it. This is similar to a case where a customer faces an event of flash crowds (spike of traffic/many requests), this is basically provisioning the clusters and servers appropriately to scale and to handle the customers requests.

To handle problem 1 we first need to detect it. Detecting such a scenario is actually easy (for instance by another thread that monitors all thread), the challenge in that case will be terminating the thread. This may cause problems in terms of consistency of data, etc. however, this is also the risk a customer takes when deploying a not optimized code. When the thread is terminated, typically the flow will continue with respect of the logic for that request (typically terminating the HTTP connection with a reset, or some error code, or in case this is configured, handle the error with another custom object, or redirect, or retrying to launch the custom object again).

Other shared resources:

There is also an issue of isolating filesystem based resources and also database data between customers.

The solution for the filesystem is simple but the coding is complicated. every custom object gets a thread for its execution (when it is launched). just before it gets the execution context, the thread will store the root namespace for that thread so that every access to file system from that thread will be limited under the configured root. As the namespace will provide a unique name to the thread, the access will be indeed limited.

For the database it is different. One option on how to handle that is with a “no-sql” kind of database that will be segmented by customer-id (or some other key). and every query to the database will include that key. As the custom object is executed in the context of the customer, the id is determined by the system, so it can't be forged by the custom object code.

Hardware Environment

FIG. 26 is an illustrative block level diagram of a computer system 2600 that can be programmed to act as a proxy server that configured to implement the processes. Computer system 2600 can include one or more processors, such as a processor 2602. Processor 2602 can be implemented using a general or special purpose processing engine such as, for example, a microprocessor, controller or other control logic. In the example illustrated in FIG. 16, processor 2602 is connected to a bus 2604 or other communication medium.

Computing system 2600 also can include a main memory 2606, preferably random access memory (RAM) or other dynamic memory, for storing information and instructions to be executed by processor 2602. In general, memory is considered a storage device accessed by the CPU, having direct access and operated in clock speeds in the order of the CPU clock, thus presenting almost no latency. Main memory 2606 also may be used for storing temporary variables or other intermediate information during execution of instructions to be executed by processor 2602. Computer system 2600 can likewise include a read only memory (“ROM”) or other static storage device coupled to bus 2604 for storing static information and instructions for processor 2602.

The computer system 2600 can also include information storage mechanism 2608, which can include, for example, a media drive 2610 and a removable storage interface 2612. The media drive 2610 can include a drive or other mechanism to support fixed or removable storage media 2614. For example, a hard disk drive, a floppy disk drive, a magnetic tape drive, an optical disk drive, a CD or DVD drive (R or RW), or other removable or fixed media drive. Storage media 2614, can include, for example, a hard disk, a floppy disk, magnetic tape, optical disk, a CD or DVD, or other fixed or removable medium that is read by and written to by media drive 2610. Information storage mechanism 2608 also may include a removable storage unit 2616 in communication with interface 2612. Examples of such removable storage unit 2616 can include a program cartridge and cartridge interface, a removable memory (for example, a flash memory or other removable memory module). As these examples illustrate, the storage media 2614 can include a computer useable storage medium having stored therein particular computer software or data. Moreover, the computer system 2600 includes a network interface 2618.

In this document, the terms “computer program device” and “computer useable device” are used to generally refer to media such as, for example, memory 2606, storage device 2608, a hard disk installed in hard disk drive 2610. These and other various forms of computer useable devices may be involved in carrying one or more sequences of one or more instructions to processor 2602 for execution. Such instructions, generally referred to as “computer program code” (which may be grouped in the form of computer programs or other groupings), when executed, enable the computing system 2600 to perform features or functions as discussed herein.

Configuration File Appendix

Attached is an example configuration file in a source code format, which is expressly incorporated herein by this reference. The configuration file appendix shows structure and information content of an example configuration file in accordance with some embodiments. This is a configuration file for a specific origin server. Line 3 describes the origin IP address to be used, and the following section (lines 4-6) describes the domains to be served for that origin. Using this when a request arrives, the server can inspect the requested host, and according to that determine which origin this request is targeted for, or in case there is no such host in the configuration, reject the request. After that (line?) is the DSA configuration—specifying if DSA is to be supported on this origin.

Following that response header are specified. These headers will be added on responses sent from the proxy server to the end-user.

The next part specify the cache settings (which may include settings specifying not to cache specific content). Initially stating the default settings, as <cache_settings . . . >, in this case specifying that the default behavior will be not to store the objects and to override the origin settings, so that regardless of what the origin will indicate to do with the content—these are the setting to be used (not to cache in this case). Also an indication to serve content from cache, if it is available in cache and expired and the server had problems getting the fresh content from the origin. After specifying the default settings, one can carve out specific characteristics in which the content should be treated otherwise. This is used by using an element called ‘cache_view’. In the view different expressions can be used to specify the pattern: path expressions (specifying the path pattern), cookies, user-agents, requestor IP address, or other parameters in the header. In this example only path expressions are used, specifying files under the directory /images/ of the types .gif, .jpe, .jpeg, and so on. Once a cache view is defined special behavior and instructions on how to handle these requests/objects can be specified: in this case—to cache these specific objects that match these criteria for 7 hours on the proxy, and to instruct the end-user to cache the objects for 1 hour. on a view also cachine parameters can be specified, like in this example (2nd page 1st line—<url_mapping object_ignore_query_string=“1”/>)—to ignore the query string in the request, i.e. not to use the query part of the request when creating the request key (the query part—being at the end of the request line, all the data following the “?” character).

Using these parameters the server will know to apply DSA behavior patterns on specific requests, while treating other requests as requests for static content that may be cached. As the handling is dramatically different, this is important to know that the earliest possible when handling such a request and this configuration enables such an early decision.

At the end of this configuration example, custom header fields are specified. These header fields will be added to the request when sending a request back to the origin. In this example, the server will add a field indicating that it is requested by the CDN server, will add the host line to indicate a requested host (this is critical when retrieving content from a host which is name is different than the published host for the service, which the end-user requested), modifying the user-agent to provide the original user agent, and add an X-forwarded-for field indicating the original end-user IP address for which the request is done (as the origin will get the request from the IP address of the requesting CDN server).

The foregoing description and drawings of preferred embodiments in accordance with the present invention are merely illustrative of the principles of the invention. For example, although much discussion herein refers to HTTP requests and responses, the same principles apply to secure HTTP requests and responses, e.g. HTTPS. Moreover, for example, although NIO is described as setting an event to signal to the thread 300/320 that a blocked action is complete, a polling technique could be used instead. Various modifications can be made to the embodiments by those skilled in the art without departing from the spirit and scope of the invention, which is defined in the appended claims.

APPENDIX
<xml>

<!-- Origin server address and server_port (if different from

80) -->

<general server_address=“127.0.0.1” />
<domains>

<domain name=“demo.com” comment=“main domain”/>

</domains>
<!-- DSA (Dynamic Site Accelleration): all content with

edge_ttl=“no store” will be treated as dynamic content and will be
accellerated -->

<dsa enabled=“1”/>
<!-- Response headers sent from CDN to the end user (can be

added / overridden) -->

<custom_response_header_fields>

<set name=“x-cdn” value=“Served by Cotendo”/>

</custom_response_header_fields>
<!-- Caching default settings for all objects in the domain/s

-->

<cache_settings user_ttl=“no_store” edge_ttl=“no_store”

override_origin=“1” on_error_respond_from_cache=“1”>

<! -- Cache view - cache settings for static objects

according to file extension -->

<cache_view name=“static-files-with-user-cache”

edge_ttl=“7h” user_ttl=“1h” override_origin=“1”>

<path exp=“/images/*.gif”/>
<path exp=“/images/*.jpe”/>
<path exp=“/images/*.jpeg”/>
<path exp=“/images/*.png”/>
<path exp=“/images/*.css”/>
<path exp=“/images/*.js”/>
<path exp=“/images/*.swf”/>
<!-- The query string will be ignored and the same

object will be served from the cache if object_ignore_query_string is
enabled -->

<url_mapping object_ignore_query_string=“1”/>
<!-- Ignores the caching view settings and get the

content from the origin according to the parameters below (for
personalized content for example) -->

<bypass_cache_settings>

<response_header_field name=“Content-Type”

exp=“image/gif”/>

<query_string exp=“*type_id=1*”

type=“wildcard_insensitive”/>

</bypass_cache_settings>

</cache_view>

</cache_settings>
<!-- if traffic was referred from http://climax-records.com to

any gif file under /images => land on
http://demo.com/messages/ref_message.htm -->

<referrer_checking default_allow=“1”

redirect_url=“http://demo.com/messages/ref_message.htm”>

<referrer_checking_view name=“referrer_1” allow=“1”>

<path exp=“/images/*.gif”/>
<referrer_domain name=“www.climax-records.com”

allow=“0”/>

</referrer_checking view>

</referrer_checking>

<!-- Request headers sent from CDN to the origin

(can be added / overridden) -->

<custom_header_fields>

<field name=“x-cdn” value=“Requested by Cotendo”/>
<field name=“Host” value=“demo.com”/>
<field name=“Referrer” value=“www.example.com”/>
<user_agent_field name=“x-orig-user-agent”/>
<forwarded_for_field name=“X-My-Forwarded-For”/>

</custom_header_fields>

</xml>

1. (canceled)

2. An article of manufacture including a computer readable storage device encoded with instructions to cause a machine that includes processing and memory resources to perform a method including:
providing in a storage device a queue of respective tasks that correspond to respective requests for content received over the internet;
providing in the storage device respective configuration files that include parameters to evaluate whether respective received requests for content are for content that is cacheable or that is dynamic and to identify respective custom objects;
wherein running a respective task includes acts of,
comparing information from a respective received request for content corresponding to the respective task with parameters in a respective configuration file to determine whether the requested content is for cacheable content or dynamic content and to identify a custom object;
in response to a determination that the respective received request is for cacheable content, determining whether the requested content is cacheable on the respective server and when the content is determined to not be cacheable on the respective server, determining one of either another server in a content delivery network or an origin server from which to request the requested content, and producing a request by the server for transmission over the internet to request the requested content from a determined server, and receiving a response to the request; and
in response to a determination that the respective received request is for dynamic content, determining one of another server from among the respective servers in the content delivery network or the origin server to which to direct a request for the dynamic content, and producing a request by the server for transmission over the internet to request the requested content from a determined another server or the origin server, and receiving a response to the request; and
running the identified custom object in the course of running the respective task to affect one or more acts of the respective task.

3. The method of claim 2,
wherein affecting one or more acts of the respective task includes blocking the request.

4. The method of claim 2,
wherein affecting one or more acts of the respective task includes generating a response page and serving the page directly.

5. The method of claim 2,
wherein affecting one or more acts of the respective task includes rewriting the respective received request.

6. The method of claim 2,
wherein affecting one or more acts of the respective task includes sending a response to redirect to a different URL.

7. The method of claim 2,
wherein the act of determining whether the requested content is cacheable involves creating a cacheable key;
wherein affecting one or more acts of the respective task includes adding a user-agent to a cacheable key.

8. The method of claim 2,
wherein the act of determining whether the requested content is cacheable involves creating a cacheable key;
wherein affecting one or more acts of the respective task includes adding a cookie value to a cacheable key.

9. The method of claim 2,
wherein the act of determining whether the requested content is cacheable involves creating a cacheable key;
wherein affecting one or more acts of the respective task includes processing a URL to determine a cacheable key.

10. The method of claim 2,
wherein affecting one or more acts of the respective task includes adding an HTTP header to a request that is produced by the server in the course of running the respective task.

11. The method of claim 2,
wherein affecting one or more acts of the respective task includes changing an origin address within a request that is produced by the server in the course of running the respective task.

12. The method of claim 2,
wherein affecting one or more acts of the respective task includes changing a host string within a request that is produced by the server in the course of running the respective task.

13. The method of claim 2,
wherein affecting one or more acts of the respective task includes adding a geo based replacement string to a response to the request that is received by the server in the course of running the respective task.

14. The method of claim 2,
wherein affecting one or more acts of the respective task includes inserting personalized information to a web page that is received by the server in the course of running the respective task.

15. The method of claim 2,
wherein affecting one or more acts of the respective task includes pre-fetching objects based upon a response received by the server in the course of running the respective task.

16. The method of claim 2,
wherein affecting one or more acts of the respective task includes triggering a new request based upon a response received by the server in the course of running the respective task.

17. The method of claim 16,
wherein the new request includes a request for personalized data for a web page.

18. The method of claim 16,
wherein the new request includes a request to a merchant that includes a token to indicate that credit card authorization has been obtained.

19. The method of claim 16,
wherein the new request includes a request to an alternate server.

20. The method of claim 2,
wherein affecting one or more acts of the respective task includes adding compression to a response to the request that is received by the server in the course of running the respective task.

21. The method of claim 2,
wherein affecting one or more acts of the respective task includes adding debug information to a response to the request that is received by the server in the course of running the respective task.

22. The method of claim 2,
wherein affecting one or more acts of the respective task includes adding flow information to a response to the request that is received by the server in the course of running the respective task.

23. The method of claim 2,
wherein affecting one or more acts of the respective task includes adding flow information to a response to the request that is received by the server in the course of running the respective task.

24. The method of claim 2,
wherein affecting one or more acts of the respective task includes adding cacheable status to a response to the request that is received by the server in the course of running the respective task.

25. The method of claim 2,
wherein affecting one or more acts of the respective task includes modifying an HTML page within a response to the request that is received by the server in the course of running the respective task.

26. The method of claim 25,
wherein modifying the HTML page within the response includes optimizing one or more URLs within the HTML page based upon device or upon location.

27. The method of claim 25,
wherein modifying the HTML page within the response includes obtaining information from a cookie in the request and including that information in the HTML page.

28. The method of claim 27,
wherein the information from the cookie includes a user name.
